(19) United States
(12) Patent Application Publication
(10) Pub. No.: US 2025/0217542 A1
(43) Pub. Date: Jul. 3, 2025

(54) CHEMICAL MECHANICAL POLISHING SYSTEM AND CHEMICAL MECHANICAL POLISHING METHOD FOR WORKPIECE

(71) Applicants: EBARA CORPORATION, Tokyo (JP); CHUO UNIVERSITY, Tokyo (JP); NATIONAL UNIVERSITY CORPORATION KANAZAWA UNIVERSITY, Ishikawa (JP)

(72) Inventors: Yuki WATANABE, Tokyo (JP); Hozumi YASUDA, Tokyo (JP); Yoshihiro MOCHIZUKI, Tokyo (JP); Norikazu SUZUKI, Tokyo (JP); Kodai HIRANO, Tokyo (JP); Yohei HASHIMOTO, Ishikawa (JP)

(21) Appl. No.: 18/990,367

(22) Filed: Dec. 20, 2024

(30) Foreign Application Priority Data
Dec. 27, 2023 (JP) 2023-220438

(51) Int. Cl. G06F 30/20; B24B 37/005

(52) U.S. Cl. CPC G06F 30/20; B24B 37/005

(57) ABSTRACT

A chemical-mechanical-polishing system for polishing a workpiece, such as a wafer, while calculating an estimated polishing rate of the workpiece using a physical model is disclosed. The chemical-mechanical-polishing system is configured to acquire measured polishing physical quantities including a measured polishing rate of a first workpiece and a measured value of torque of a polishing apparatus during or after polishing of the first workpiece; identify the model parameters of the simulation model using the measured polishing physical quantities as variables for identification; and input polishing conditions for a second workpiece into the simulation model to calculate an estimated polishing rate of the second workpiece.

### CROSS REFERENCE TO RELATED APPLICATION

This document claims priority to Japanese Patent Application No. 2023-220438 filed Dec. 27, 2023, the entire contents of which are hereby incorporated by reference.

### BACKGROUND

In manufacturing of semiconductor devices, various types of films are formed on a wafer. After the film forming process, the wafer is polished in order to remove unnecessary parts of the film and surface irregularities. Chemical mechanical polishing (CMP) is a typical technique for the wafer polishing. CMP is performed by rubbing the wafer against a polishing surface while supplying slurry onto the polishing surface. A film that forms the surface of the wafer is polished by a combination of a chemical action of the slurry and a mechanical action of abrasive grains contained in the slurry.

Simulation techniques for wafer polishing have been developed for the purpose of estimating a film thickness of a wafer and detecting an end point of wafer polishing. Machine learning, such as deep learning, is a typical technique for polishing simulation. For example, a model constituted of a neural network is created by machine learning, and polishing conditions for a wafer are input into the model, so that an estimated value of a polishing result is output from the model. Polishing estimation by such machine learning is expected as a technique capable of obtaining an estimation result closer to actual polishing.

However, a large amount of training data (so-called big data) is required for the operations of producing a model by the machine learning. In particular, in order to create a model that can output more accurate polishing result, a larger amount of data is required. As a result, it takes a long time to create the model. Furthermore, since the model itself has a complicated structure, it takes a relatively long time for the model to output the polishing result.

In addition, the model constituted of the neural network is a so-called black box, and it is unknown what structure it has (or what weight parameters it has). Therefore, if an actual polishing result and the polishing result output from the model are different, it is impossible to identify a part to be corrected in the model. In order to correct the model, additional training data is required and it takes a long time to correct the model.

### SUMMARY

There are provided a chemical-mechanical-polishing system and a chemical-mechanical-polishing method for polishing a workpiece, such as a wafer, while calculating an estimated polishing rate of the workpiece using a physical model.

Embodiments, which will be described below, relate to chemical mechanical polishing for polishing a surface of a workpiece, such as a wafer, a substrate, or a panel, and more particularly to a technique for polishing a workpiece while estimating a polishing rate of the workpiece using a simulation model constructed based on actual measurement data of chemical mechanical polishing.

In an embodiment, there is provided a chemical-mechanical-polishing system comprising: a polishing apparatus including a polishing table configured to support a polishing pad having a polishing surface, a polishing head configured to press a workpiece against the polishing surface, and a slurry supply nozzle configured to supply a slurry onto the polishing surface; and an arithmetic system having a memory storing therein a simulation model configured to output estimated polishing physical quantities including an estimated polishing rate of the workpiece and an estimated torque which is an estimated value of a torque generated in the polishing apparatus due to a sliding resistance of the polishing pad, wherein the simulation model includes a polishing rate model configured to calculate the estimated polishing rate and a polishing torque model configured to calculate the estimated torque, the memory stores an identification program configured to determine model parameters of the simulation model, the arithmetic system is configured to: acquire measured polishing physical quantities including a measured polishing rate of a first workpiece and a measured value of the torque during or after polishing of the first workpiece; identify the model parameters of the simulation model using the measured polishing physical quantities as variables for identification; and input polishing conditions for a second workpiece into the simulation model to calculate an estimated polishing rate of the second workpiece.

In an embodiment, the arithmetic system is configured to: calculate differences between predetermined reference model parameters and the model parameters by subtracting the model parameters from the predetermined reference model parameters after the model parameters are identified; and update the simulation model by substituting the differences as corrected model parameters into the simulation model.

In an embodiment, the arithmetic system is configured to: calculate a correction amount based on differences between estimated polishing physical quantities obtained from polishing of a previous workpiece performed before polishing of the first workpiece and measured polishing physical quantities obtained from polishing of the previous workpiece; and determine the model parameters for the first workpiece by adding the correction amount to model parameters obtained from polishing of the previous workpiece.

In an embodiment, there is provided a chemical-mechanical-polishing method of polishing a workpiece using a polishing apparatus including a polishing table supporting a polishing pad having a polishing surface, a polishing head configured to press the workpiece against the polishing surface, and a slurry supply nozzle configured to supply a slurry onto the polishing surface, said method comprising: polishing a first workpiece with the polishing apparatus; during or after polishing of the first workpiece, acquiring measured polishing physical quantities including a measured polishing rate of the first workpiece and a measured value of torque generated in the polishing apparatus due to a sliding resistance of the polishing pad; identifying model parameters of a simulation model using the measured polishing physical quantities as variables for identification by an arithmetic system which includes an identification program configured to determine the model parameters of the simulation model, the simulation model including a polishing rate model configured to calculate an estimated polishing rate of a workpiece and a polishing torque model configured to calculate an estimated torque as an estimated value of the torque; and inputting polishing conditions for a second workpiece into the simulation model to calculate an estimated polishing rate of the second workpiece.

In an embodiment, the chemical-mechanical-polishing method further comprises: calculating differences between predetermined reference model parameters and the model parameters by subtracting the model parameters from the predetermined reference model parameters after the model parameters are identified; and updating the simulation model by substituting the differences as corrected model parameters into the simulation model.

In an embodiment, determining the model parameters of the simulation model comprises: calculating a correction amount based on differences between estimated polishing physical quantities obtained from polishing of a previous workpiece performed before polishing of the first workpiece and measured polishing physical quantities obtained from polishing of the previous workpiece; and determining the model parameters for the first workpiece by adding the correction amount to model parameters obtained from polishing of the previous workpiece.

In an embodiment, there is provided a chemical-mechanical-polishing system comprising: a polishing apparatus including a polishing table configured to support a polishing pad having a polishing surface, a polishing head configured to press a workpiece against the polishing surface, and a slurry supply nozzle configured to supply a slurry onto the polishing surface; and an arithmetic system having a memory storing therein a simulation model configured to output estimated polishing physical quantities including an estimated polishing rate of the workpiece and an estimated torque which is an estimated value of a torque generated in the polishing apparatus due to a sliding resistance of the polishing pad, wherein the simulation model includes a polishing rate model configured to calculate the estimated polishing rate and a polishing torque model configured to calculate the estimated torque, the memory stores an identification program configured to determine model parameters of the simulation model, the arithmetic system is configured to: identify the model parameters of the simulation model using, as variables for identification, a measured polishing rate and a measured torque obtained in polishing of a previous workpiece performed before polishing of the workpiece; set multiple estimation segments in a polishing time of the workpiece; acquire measured polishing physical quantities including a measured value of the torque in one of the multiple estimation segments during polishing of the workpiece; update the model parameters of the simulation model by identifying a part of the model parameters using the measured polishing physical quantities as variables for identification; update the simulation model using the updated model parameters; and input polishing conditions into the updated simulation model to calculate an estimated polishing rate of the workpiece in the one of the multiple estimation segments.

In an embodiment, the arithmetic system is configured to: calculate a post-estimated torque by applying a Kalman filter to an estimated torque calculated using the polishing torque model in an estimation segment prior to the one of the multiple estimation segments and the measured value of the torque obtained in the one of the multiple estimation segments; and update the model parameters of the simulation model by identifying a part of the model parameters using the measured polishing physical quantities including the post-estimated torque as variables for identification.

In an embodiment, there is provided a chemical-mechanical-polishing method of polishing a workpiece using a polishing apparatus including a polishing table supporting a polishing pad having a polishing surface, a polishing head configured to press the workpiece against the polishing surface, and a slurry supply nozzle configured to supply a slurry onto the polishing surface, said method comprising: identifying model parameters of a simulation model using, as variables for identification, a measured polishing rate and a measured torque obtained in polishing of a previous workpiece performed before polishing of the workpiece, the simulation model including a polishing rate model configured to calculate an estimated polishing rate of the workpiece and a polishing torque model configured to calculate an estimated torque which is an estimated value of a torque generated in the polishing apparatus due to a sliding resistance of the polishing pad; setting multiple estimation segments in a polishing time of the workpiece; acquiring measured polishing physical quantities including a measured value of the torque in one of the multiple estimation segments during polishing of the workpiece; updating the model parameters of the simulation model by identifying a part of the model parameters using the measured polishing physical quantities as variables for identification; updating the simulation model using the updated model parameters; and inputting polishing conditions into the updated simulation model to calculate an estimated polishing rate of the workpiece in the one of the multiple estimation segments.

In an embodiment, the chemical-mechanical-polishing method further comprises: calculating a post-estimated torque by applying a Kalman filter to an estimated torque calculated using the polishing torque model in an estimation segment prior to the one of the multiple estimation segments and the measured value of the torque obtained in the one of the multiple estimation segments, wherein updating the simulation model comprises updating the model parameters of the simulation model by identifying a part of the model parameters using the measured polishing physical quantities including the post-estimated torque as variables for identification.

In an embodiment, there is provided a chemical-mechanical-polishing system comprising: a polishing apparatus including a polishing table configured to support a polishing pad having a polishing surface, a polishing head configured to press a workpiece against the polishing surface, and a slurry supply nozzle configured to supply a slurry onto the polishing surface; and an arithmetic system having a memory storing therein a simulation model configured to output estimated polishing physical quantities including an estimated polishing rate of the workpiece and an estimated torque which is an estimated value of a torque generated in the polishing apparatus due to a sliding resistance of the polishing pad, wherein the simulation model includes a polishing rate model configured to calculate the estimated polishing rate and a polishing torque model configured to calculate the estimated torque, the memory stores an identification program configured to determine model parameters of the simulation model, the arithmetic system is configured to: obtain initial measured polishing physical quantities from polishing of a sample using the polishing pad in an initial state; determine initial values of the model parameters using the initial measured polishing physical quantities as variables for identification; calculate an initial Preston coefficient from the initial values of the model parameters; set multiple estimation segments in a polishing time of the workpiece; input polishing conditions into the simulation model to calculate an initial estimated torque; obtain a measured value of the torque in a first estimation segment of the multiple estimation segments during polishing of the workpiece; calculate a correction amount by multiplying a difference between the measured value of the torque and the initial estimated torque by a predetermined correction coefficient; determine a corrected Preston coefficient by adding the correction amount to the initial Preston coefficient; update the polishing rate model by substituting the corrected Preston coefficient into the polishing rate model; and calculate an estimated polishing rate of the workpiece in a second estimation segment of the multiple estimation segments by inputting polishing conditions for the second estimation segment into the polishing rate model.

In an embodiment, there is provided a chemical-mechanical-polishing method of polishing a workpiece using a polishing apparatus including a polishing table supporting a polishing pad having a polishing surface, a polishing head configured to press the workpiece against the polishing surface, and a slurry supply nozzle configured to supply a slurry onto the polishing surface, said method comprising: obtaining initial measured polishing physical quantities from polishing of a sample using the polishing pad in an initial state; identifying initial values of model parameters of a simulation model using the initial measured polishing physical quantities as variables for identification by an arithmetic system which includes an identification program configured to determine the model parameters of the simulation model, the simulation model including a polishing rate model configured to calculate an estimated polishing rate of the workpiece and a polishing torque model configured to calculate an estimated torque as an estimated value of a torque generated in the polishing apparatus due to a sliding resistance of the polishing pad; calculating an initial Preston coefficient from the initial values of the model parameters; setting multiple estimation segments in a polishing time of the workpiece; inputting polishing conditions into the simulation model to calculate an initial estimated torque; obtaining a measured value of the torque in a first estimation segment of the multiple estimation segments during polishing of the workpiece; calculating a correction amount by multiplying a difference between the measured value of the torque and the initial estimated torque by a predetermined correction coefficient; determining a corrected Preston coefficient by adding the correction amount to the initial Preston coefficient; updating the polishing rate model by substituting the corrected Preston coefficient into the polishing rate model; and calculating an estimated polishing rate of the workpiece in a second estimation segment of the multiple estimation segments by inputting polishing conditions for the second estimation segment into the polishing rate model.

The polishing-rate model and the polishing-torque model, which are the physical models included in the simulation model, are virtual chemical mechanical polishing system that imitates an actual polishing apparatus. The model parameters that construct the simulation model are identified based on a comparison between the measured polishing physical quantity (e.g., a measured polishing rate, a measured machine torque, etc.) obtained from the actual polishing apparatus and the estimated polishing physical quantity (e.g., an estimated polishing rate, an estimated machine torque, etc.) obtained from the simulation model. More specifically, the model parameters for bringing the estimated polishing physical quantity closer to the measured polishing physical quantity are determined. Therefore, the simulation model can accurately calculate an estimated polishing rate of a workpiece.

### BRIEF DESCRIPTION OF THE DRAWINGS

FIG. 1 is a schematic diagram showing an embodiment of a chemical mechanical polishing system;

FIG. 2 is a cross-sectional diagram of a polishing head shown in FIG. 1;

FIG. 3 is a flowchart explaining a method of identifying unknown model parameters of a simulation model;

FIG. 4 is a schematic diagram showing velocity vectors on the polishing head, a workpiece, and a dresser on a polishing pad;

FIG. 5 is a schematic diagram explaining a pad-rotation torque model;

FIG. 6 is a schematic diagram showing a distribution of coefficients of friction of a workpiece;

FIG. 7 is a graph showing a relationship between torque of the polishing pad and polishing time;

FIG. 8 is a flow chart illustrating one embodiment of polishing a workpiece using the chemical mechanical polishing system;

FIG. 9 is a block diagram illustrating one embodiment of identifying model parameters and calculating estimated polishing rate;

FIG. 10 is a block diagram illustrating another embodiment of identifying model parameters and calculating estimated polishing rate;

FIG. 11 is a block diagram illustrating yet another embodiment of identifying model parameters and calculating estimated polishing rate;

FIG. 12 is a flow chart illustrating another embodiment of polishing a workpiece using a chemical mechanical polishing system;

FIG. 13 is a graph showing an example of a plurality of estimation segments set within a polishing time of one workpiece;

FIG. 14 is a block diagram illustrating one embodiment of identifying model parameters and calculating estimated polishing rate;

FIG. 15 is a block diagram illustrating yet another embodiment for polishing a workpiece using a chemical mechanical polishing system;

FIG. 16 is a block diagram illustrating yet another embodiment for polishing a workpiece using a chemical mechanical polishing system;

FIG. 17 is a flow chart of the embodiment described with reference to FIG. 16; and

FIG. 18 is a flow chart of the embodiment described with reference to FIG. 16.

### DESCRIPTION OF EMBODIMENTS

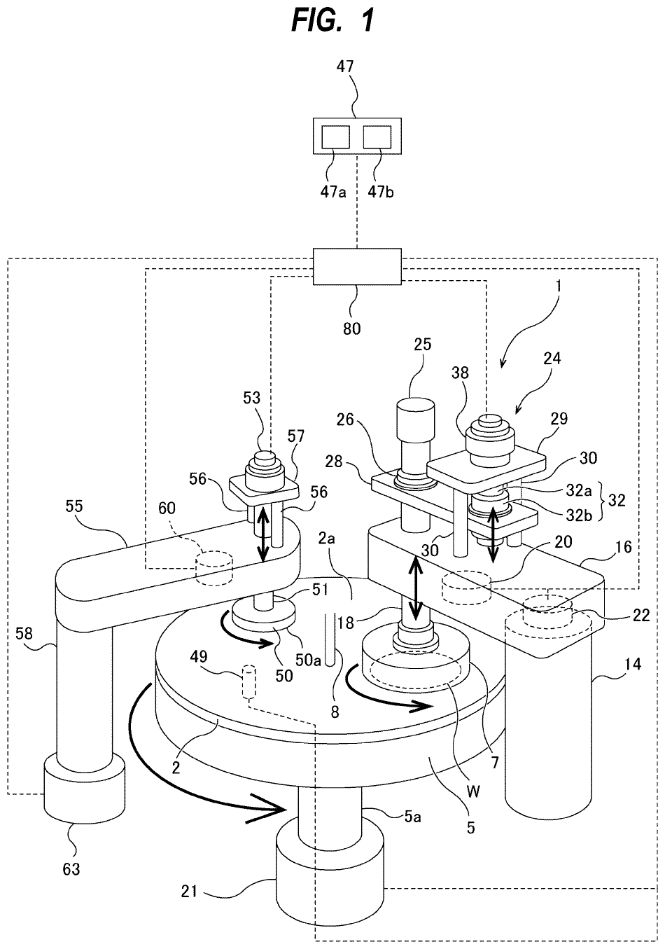

Hereinafter, embodiments will be described with reference to the drawings. FIG. 1 is a schematic diagram showing an embodiment of a chemical mechanical polishing system. As shown in FIG. 1, the chemical mechanical polishing system includes a polishing apparatus 1 configured to chemically mechanically polish a workpiece W. The polishing apparatus 1 includes a polishing table 5 configured to support a polishing pad 2 having a polishing surface 2a, a polishing head 7 configured to press the workpiece W (e.g., a wafer, a substrate, or a panel) against the polishing surface 2a, a slurry supply nozzle 8 configured to supply slurry containing abrasive grains onto the polishing surface 2a, and an operation controller 80 configured to control operations of the polishing apparatus 1. The polishing head 7 is configured to be able to hold the workpiece W on a lower surface of the polishing head 7.

The polishing apparatus 1 further includes a support shaft 14, a polishing-head oscillation arm 16 coupled to an upper end of the support shaft 14 and configured to oscillate the polishing head 7, a polishing-head shaft 18 rotatably supported by a free end of the polishing-head oscillation arm 16, and a polishing-head rotating motor 20 configured to rotate the polishing head 7 about its axis. The polishing-head rotating motor 20 is arranged in the polishing-head oscillation arm 16 and is coupled to the polishing-head shaft 18 via a torque transmission mechanism (not shown) composed of a belt, pulleys, etc. The polishing head 7 is coupled to a lower end of the polishing-head shaft 18. The polishing-head rotating motor 20 rotates the polishing-head shaft 18 via the torque transmission mechanism, and the polishing head 7 rotates together with the polishing-head shaft 18. In this way, the polishing head 7 is rotated about its axis by the polishing-head rotating motor 20 in a direction indicated by arrow.

The polishing apparatus 1 further includes a table rotating motor 21 configured to rotate the polishing pad 2 and the polishing table 5 about their axes. The table rotating motor 21 is arranged below the polishing table 5, and the polishing table 5 is coupled to the table rotating motor 21 via a table shaft 5a. The polishing table 5 and the polishing pad 2 are rotated by the table rotating motor 21 about the table shaft 5a in a direction indicated by arrow. The axes of the polishing pad 2 and the polishing table 5 coincide with the axis of the table shaft 5a. The polishing pad 2 is attached to an upper surface of the polishing table 5. An upper surface of the polishing pad 2 constitutes the polishing surface 2a for polishing the workpiece W, such as wafer.

The polishing-head shaft 18 is movable up and down relative to the polishing-head oscillation arm 16 by an elevating mechanism 24. This vertical movement of the polishing-head shaft 18 causes the polishing head 7 to move up and down relative to the polishing-head oscillation arm 16. A rotary joint 25 is attached to an upper end of the polishing-head shaft 18.

The polishing apparatus 1 further includes a polishing-head oscillation motor 22 configured to oscillate the polishing head 7 on the polishing surface 2a. The polishing-head oscillation motor 22 is coupled to the polishing-head oscillation arm 16. The polishing-head oscillation arm 16 is configured to be rotatable about the support shaft 14. The polishing-head oscillation motor 22 is configured to swing the polishing-head oscillation arm 16 clockwise and counterclockwise by a predetermined angle around the support shaft 14, so that the polishing head 7 oscillates on the polishing pad 2 while the polishing head 7 is pressing the workpiece W against the polishing surface 2a of the polishing pad 2.

In the present embodiment, the polishing-head oscillation motor 22 is mounted to the upper end of the support shaft 14, and is arranged so as to swing the polishing-head oscillation arm 16 without rotating the support shaft 14. In one embodiment, the polishing-head oscillation arm 16 may be fixed to the support shaft 14, and the polishing-head oscillation motor 22 may be coupled to the support shaft 14 so as to rotate the support shaft 14 together with the polishing-head oscillation arm 16.

The elevating mechanism 24 for elevating and lowering the polishing-head shaft 18 and the polishing head 7 includes a bearing 26 that rotatably supports the polishing-head shaft 18, a bridge 28 to which the bearing 26 is fixed, a ball screw mechanism 32 attached to the bridge 28, a support base 29 supported by support columns 30, and a servomotor 38 fixed to the support base 29. The support base 29 that supports the servomotor 38 is coupled to the polishing-head oscillation arm 16 via the support columns 30.

The ball screw mechanism 32 includes a screw shaft 32a coupled to the servomotor 38 and a nut 32b into which the screw shaft 32a is screwed. The nut 32b is fixed to the bridge 28. The polishing-head shaft 18 is movable up and down (movable in the vertical direction) together with the bridge 28. Therefore, when the servomotor 38 drives the ball screw mechanism 32, the bridge 28 moves up and down, thus causing the polishing-head shaft 18 and the polishing head 7 to move up and down.

Polishing of the workpiece W is performed as follows. While the polishing head 7 and the polishing table 5 are rotating, the slurry is supplied onto the polishing surface 2a of the polishing pad 2 from the slurry supply nozzle 8 provided above the polishing table 5. The polishing pad 2 rotates together with the polishing table 5 about the axis of the polishing pad 2. The polishing head 7 is lowered to a predetermined polishing position by the elevating mechanism 24. Further, the polishing head 7 presses the workpiece W against the polishing surface 2a of the polishing pad 2 at the polishing position. The workpiece W is placed in sliding contact with the polishing surface 2a of the polishing pad 2 in the presence of the slurry on the polishing surface 2a of the polishing pad 2. The surface of the workpiece W is polished by a combination of a chemical action of the slurry and a mechanical action of the abrasive grains contained in the slurry.

The polishing apparatus 1 includes a film-thickness sensor 49 for measuring a film thickness of the workpiece W on the polishing surface 2a of the polishing pad 2. The film-thickness sensor 49 is disposed in the polishing table 5 and rotates together with the polishing table 5 and the polishing pad 2. The film-thickness sensor 49 is configured to measure the film thickness of the workpiece W while moving across the surface of the workpiece W held by the polishing head 7. The film thickness of the workpiece W measured by the film-thickness sensor 49 is sent to the operation controller 80 and an arithmetic system 47. The specific configuration of the film-thickness sensor 49 is not particularly limited as long as the film-thickness sensor 49 can measure the film thickness of the workpiece W. For example, the film-thickness sensor 49 is an optical film-thickness sensor or an eddy current film-thickness sensor.

The film-thickness sensor 49 is a so-called in-situ film-thickness measuring device incorporated in the polishing apparatus 1 that polishes the workpiece W. In one embodiment, instead of the film-thickness sensor 49, an ex-situ film-thickness measuring device provided outside the polishing apparatus 1 may be provided. Before and after polishing of the workpiece W, the film thickness of the workpiece W is measured by the ex-situ film-thickness measuring device. Measured value of the film thickness is sent to the operation controller 80 and the arithmetic system 47.

The polishing apparatus 1 includes a dresser 50 configured to dress the polishing surface 2a of the polishing pad 2, a dresser shaft 51 to which the dresser 50 is coupled, an air cylinder 53 as a dresser-pressing actuator mounted to an upper end of the dresser shaft 51, a dresser oscillation arm 55 that rotatably supports the dresser shaft 51, and a support shaft 58 to which the dresser oscillation arm 55 is fixed.

The dresser 50 has a lower surface that constitutes a dressing surface 50a. This dressing surface 50a is composed of abrasive grains (for example, diamond particles). The air cylinder 53 is arranged on a support base 57 supported by columns 56, and these columns 56 are fixed to the dresser oscillation arm 55. The air cylinder 53 is coupled to the dresser 50 via the dresser shaft 51. The air cylinder 53 is configured to vertically move the dresser shaft 51 and the dresser 50 together and press the dressing surface 50a of the dresser 50 against the polishing surface 2a of the polishing pad 2 with a predetermined force. Instead of the air cylinder 53, a combination with a servomotor and a ball screw mechanism may be used as the dresser-pressing actuator.

The polishing apparatus 1 further includes a dresser rotating motor 60 configured to rotate the dresser 50 about its axis. The dresser rotating motor 60 is arranged in the dresser oscillation arm 55, and is coupled to the dresser shaft 51 via a torque transmission mechanism (not shown) composed of a belt, pulleys, etc. The dresser 50 is coupled to a lower end of the dresser shaft 51. The dresser rotating motor 60 rotates the dresser shaft 51 via the torque transmission mechanism, and the dresser 50 is rotated together with the dresser shaft 51. In this way, the dresser 50 is rotated about the axis thereof by the dresser rotating motor 60 in a direction indicated by arrow.

The polishing apparatus 1 further includes a dresser oscillation motor 63 configured to oscillate the dresser 50 on the polishing surface 2a. The dresser oscillation motor 63 is coupled to the support shaft 58. The dresser oscillation arm 55 is configured to be rotatable together with the support shaft 58 about the support shaft 58. The dresser oscillation motor 63 is configured to swing the dresser oscillation arm 55 clockwise and counterclockwise by a predetermined angle around the support shaft 58, so that the dresser 50 oscillates on the polishing pad 2 in the radial direction of the polishing pad 2 while the dresser 50 is pressing the dressing surface 50a against the polishing surface 2a of the polishing pad 2.

In the present embodiment, the dresser oscillation arm 55 is fixed to the support shaft 58, and the dresser oscillation motor 63 is coupled to the support shaft 58 so as to rotate the support shaft 58 together with the dresser oscillation arm 55. In one embodiment, the dresser oscillation motor 63 may be mounted to the upper end of the support shaft 58 and may be arranged so as to swing the dresser oscillation arm 55 without rotating the support shaft 58.

Dressing of the polishing surface 2a of the polishing pad 2 is performed as follows. During polishing of the workpiece W, the dresser 50 is rotated about the dresser shaft 51, and the dressing surface 50a of the dresser 50 is pressed against the polishing surface 2a by the air cylinder 53. The dresser 50 is placed in sliding contact with the polishing surface 2a in the presence of the slurry on the polishing surface 2a. While the dresser 50 is in sliding contact with the polishing surface 2a, the dresser oscillation motor 63 swings the dresser oscillation arm 55 clockwise and counterclockwise about the support shaft 58 by a predetermined angle, so that the dresser 50 is moved in the radial direction of the polishing pad 2. In this way, the polishing pad 2 is scraped off by the dresser 50, and dressing (i.e., regeneration) of the polishing surface 2a is achieved.

In the present embodiment, the dressing of the polishing surface 2a is performed during the polishing of the workpiece W, while in one embodiment, the dressing of the polishing surface 2a may be performed after the polishing of the workpiece W. In this case, pure water may be supplied onto the polishing surface 2a instead of the slurry during dressing.

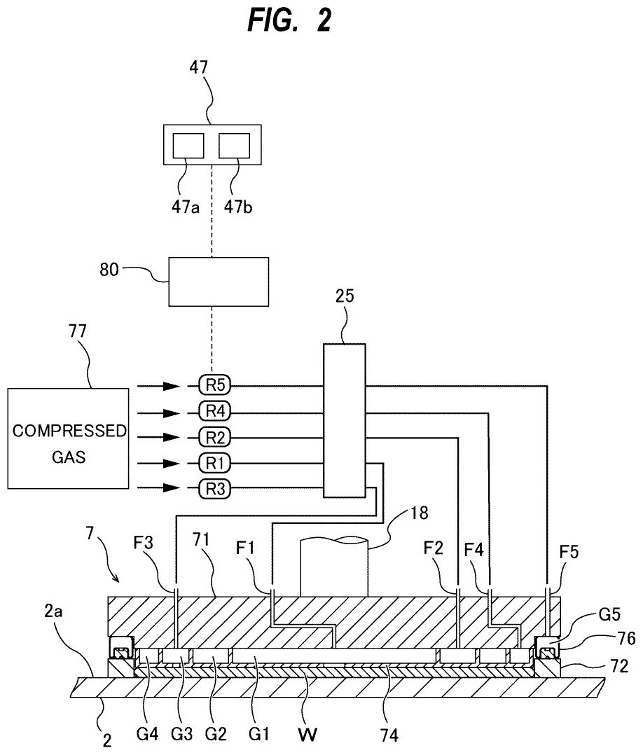

FIG. 2 is a cross-sectional view of the polishing head 7 shown in FIG. 1. The polishing head 7 includes a carrier 71 fixed to the polishing-head shaft 18, and a retainer ring 72 arranged below the carrier 71. A flexible membrane (or an elastic membrane) 74, which is arranged to contact the workpiece W, is held on a lower portion of the carrier 71. Four pressure chambers G1, G2, G3 and G4 are formed between the membrane 74 and the carrier 71. The pressure chambers G1, G2, G3 and G4 are formed by the membrane 74 and the carrier 71. The central pressure chamber G1 is circular, and the other pressure chambers G2, G3, and G4 are annular. These pressure chambers G1, G2, G3 and G4 are concentrically arranged. In one embodiment, more than four pressure chambers may be provided, or less than four pressure chambers may be provided.

Compressed gas, such as compressed air, is supplied into the pressure chambers G1, G2, G3, and G4 by a gas supply source 77 via fluid passages F1, F2, F3, and F4, respectively. The workpiece W is pressed against the polishing surface 2a of the polishing pad 2 by the membrane 74. More specifically, pressures of the compressed gas in the pressure chambers G1, G2, G3 and G4 act on the workpiece W via the membrane 74 to press the workpiece W against the polishing surface 2a. The pressures in the pressure chambers G1, G2, G3 and G4 can be changed independently, so that polishing pressures on corresponding four regions of the workpiece W, namely a central portion, an inner intermediate portion, an outer intermediate portion, and a peripheral portion, can be regulated independently. The pressure chambers G1, G2, G3 and G4 communicate with a vacuum source (not shown) via the fluid passages F1, F2, F3 and F4.

An annular rolling diaphragm 76 is arranged between the carrier 71 and the retainer ring 72, and a pressure chamber G5 is formed inside the rolling diaphragm 76. The pressure chamber G5 communicates with the gas supply source 77 via a fluid passage F5. The gas supply source 77 supplies the compressed gas into the pressure chamber G5, and the compressed gas in the pressure chamber G5 presses the retainer ring 72 against the polishing surface 2a of the polishing pad 2.

The peripheral portion of the workpiece W and a lower surface (i.e., a workpiece pressing surface) of the membrane 74 are surrounded by the retainer ring 72. During polishing of the workpiece W, the retainer ring 72 presses the polishing surface 2a of the polishing pad 2 outside the workpiece W so as to prevent the workpiece W from coming off from the polishing head 7 during polishing of the workpiece W.

The fluid passages F1, F2, F3, F4, and F5 extend from the pressure chambers G1, G2, G3, G4, and G5 to the gas supply source 77 via the rotary joint 25. Pressure regulators R1, R2, R3, R4, and R5 are attached to the fluid passages F1, F2, F3, F4, and F5, respectively. The compressed gas from the gas supply source 77 is supplied into the pressure chambers G1 to G5 through the pressure regulators R1 to R5, the rotary joint 25, and the fluid passages F1 to F5.

The pressure regulators R1, R2, R3, R4, and R5 are configured to regulate the pressures in the pressure chambers G1, G2, G3, G4, and G5. The pressure regulators R1, R2, R3, R4 and R5 are coupled to the operation controller 80. The operation controller 80 is coupled to the arithmetic system 47. The fluid passages F1, F2, F3, F4, and F5 are further coupled to vent valves (not shown), so that the pressure chambers G1, G2, G3, G4, and G5 can be ventilated to the atmosphere.

The operation controller 80 is configured to generate target pressure values for the pressure chambers G1 to G5, respectively. The operation controller 80 sends the target pressure values to the pressure regulators R1 to R5, and the pressure regulators R1 to R5 operate such that the pressures in the pressure chambers G1 to G5 coincide with the corresponding target pressure values. Since the polishing head 7 having the plurality of pressure chambers G1, G2, G3, and G4 can independently press the corresponding regions of the surface of the workpiece W against the polishing pad 2 based on the progress of polishing, the polishing head 7 can polish a film of the workpiece W uniformly.

During the polishing of the workpiece W, the polishing head 7 is maintained at a reference height. The reference height of the polishing head 7 is a relative height of the entire polishing head 7 with respect to the polishing surface 2a of the polishing pad 2. The compressed gas is supplied to the pressure chambers G1, G2, G3, G4, and G5 with the polishing head 7 at the reference height. The membrane 74 forming the pressure chambers G1, G2, G3 and G4 presses the workpiece W against the polishing surface 2a of the polishing pad 2, and the rolling diaphragm 76 forming the pressure chamber G5 presses the retainer ring 72 against the polishing surface 2a of the polishing pad 2.

Referring back to FIG. 1, the chemical mechanical polishing system further includes an arithmetic system 47 having a simulation model for simulating the polishing of the workpiece W and calculating estimated polishing physical quantities of the workpiece W. The arithmetic system 47 is electrically coupled to the polishing apparatus 1. More specifically, the arithmetic system 47 is coupled to the operation controller 80. The simulation model represents a virtual polishing apparatus that imitates the above-discussed polishing apparatus 1 including the polishing table 5, the polishing head 7, and the dresser 50. The actual polishing apparatus 1 and the simulation model, which is the virtual polishing apparatus constructed in a virtual space, constitute a digital twin. A system that utilizes such a digital twin is a called cyber-physical system in which a simulation result is fed back to the real world so that optimum control is performed (for example, control is performed so that the workpiece can be polished to have a flatter surface).

When preset polishing conditions are input to the simulation model, the simulation model performs virtual chemical mechanical polishing of the workpiece W using the virtual polishing apparatus, and outputs estimated polishing physical quantities, such as an estimated polishing rate of the workpiece W. Examples of the polishing conditions include a rotation speed of the polishing table 5 [min⁻¹ or rad/s], a rotation speed of the polishing head 7 [min⁻¹ or rad/s], pressure [Pa] applied from the workpiece W to the polishing surface 2a of the polishing pad 2, pressure [Pa] applied from the retainer ring 72 to the polishing surface 2a of the polishing pad 2, a relative position between the polishing head 7 and the polishing pad 2, a rotation speed of the dresser 50 [min⁻¹ or rad/s], pressure [Pa] applied from the dresser 50 to the polishing surface 2a of the polishing pad 2, a relative position between the dresser 50 and the polishing pad 2, and a position and a flow rate of the slurry supplied. The polishing rate is defined as an amount of surface material of the workpiece W removed per unit time. The polishing rate may be referred to as a material removal rate.

The arithmetic system 47 includes a memory 47a in which programs and the simulation model are stored, and a processor 47b configured to perform arithmetic operations according to instructions included in the programs. The memory 47a includes a main memory, such as RAM, and an auxiliary memory, such as hard disk drive (HDD) or solid state drive (SSD). Examples of the processor 47b include a CPU (central processing unit) and a GPU (graphic processing unit). However, the specific configurations of the arithmetic system 47 are not limited to these examples.

The arithmetic system 47 is composed of at least one computer. The at least one computer may be one server or a plurality of servers. The arithmetic system 47 may be an edge server, a cloud server coupled to a communication network, such as the Internet or a local area network, or a fog server installed in a network. The arithmetic system 47 may be a plurality of servers coupled by a communication network, such as the Internet or a local area network. For example, the arithmetic system 47 may be a combination of an edge server and a cloud server.

The arithmetic system 47 and the operation controller 80 may be an integrated device. The arithmetic system 47 and the operation controller 80 may be virtually constructed by one or more computers.

The simulation model is composed of at least a physical model configured to output the estimated polishing physical quantities. The simulation model is stored in the memory 47a. The physical model includes at least a polishing-rate model and a polishing-torque model. The polishing-rate model is a physical model for calculating an estimated polishing rate, which is an example of the estimated polishing physical quantity. The polishing-torque model is a physical model for calculating an estimated value of torque required for each mechanical element of the polishing apparatus 1 due to a sliding resistance of the polishing pad 2. The estimated value of torque is also an example of the estimated polishing physical quantity as well as the estimated polishing rate. Specific examples of the torque include a polishing-head rotation torque for rotating the polishing head 7 and the workpiece W about the axis of the polishing head 7, a polishing-pad rotation torque for rotating the polishing pad 2 (or the polishing table 5) about its axis, a dresser rotation torque for rotating the dresser 50 about its axis, a dresser oscillation torque around an oscillation axis required to oscillate the dresser 50 on the polishing pad 2, and a head oscillation torque around an oscillation axis required to oscillate the polishing head 7 on the polishing pad 2.

The simulation model contains multiple model parameters. These model parameters include known model parameters determined by the polishing conditions (e.g., the polishing pressure, the rotation speed of the polishing head 7, the rotation speed of the polishing pad 2), and unknown model parameters, such as a coefficient of friction of the workpiece W. Once the unknown model parameters are determined, the estimated polishing physical quantities (e.g., the estimated polishing rate and the estimated values of the various torques) of the workpiece W can be output from the simulation model by inputting the polishing conditions into the simulation model.

Measured polishing physical quantities include an measured polishing rate of the workpiece W and measured values of various torques required in the polishing of the workpiece W. These measured polishing physical quantities can be determined from measurement data. The arithmetic system 47 is configured to identify or determine the unknown model parameters of the simulation model by using the measured polishing physical quantities, obtained by actual polishing, as variables for identification. Identification of the unknown model parameters is to bring the unknown model parameters closer to optimum values.

The programs stored in the memory 47a of the arithmetic system 47 include an identification program for identifying or determining the unknown model parameters. The arithmetic system 47 operates according to instructions included in the identification program, and identifies the model parameters of the simulation model for bringing the estimated polishing physical quantities of the workpiece closer to the measured polishing physical quantities of the workpiece. The measured polishing physical quantities of the workpiece include a measured polishing rate of the workpiece and measured values of the torques. The estimated polishing physical quantities of the workpiece include an estimated polishing rate of the workpiece and estimated values of the torques.

The polishing apparatus 1 polishes at least one workpiece under predetermined polishing conditions, and the arithmetic system 47 acquires the measured polishing physical quantities determined from the polishing of the workpiece and stores the measured polishing physical quantities in the memory 47a. The predetermined polishing conditions may be, for example, actual polishing conditions for the workpiece or may be preset polishing conditions for test polishing. The polishing conditions may be changed dynamically during polishing. In this case, improved identification accuracy may be achieved and an advanced basis function may be used. The measured polishing physical quantities include the measured polishing rate of the workpiece, and the measured values of the torques of the polishing head 7, the polishing pad 2 (or the polishing table 5), and the dresser 50 when the workpiece is being polished. The measured values of the torques may be values that directly indicate the torques, such as measurements of torque meters (not shown), or may be values that indirectly indicate the torques, such as values of torque currents supplied to the polishing-head rotating motor 20, the table rotating motor 21, and the dresser rotating motor 60, or may be torque estimated values calculated from these torque currents. In one example, the measured values of the torques may be values that indirectly estimate the polishing torques on a model basis from a mechanical model of the mechanical structure and in-process information of the motor currents and acceleration/deceleration physical quantities. The polishing-head rotating motor 20, the table rotating motor 21, and the dresser rotating motor 60 are controlled so as to rotate the polishing head 7, the polishing table 5, and the dresser 50 at predetermined constant speeds, respectively. Therefore, as the sliding resistances acting on the polishing head 7, the polishing pad 2, and the dresser 50 increase, the torque currents also increase.

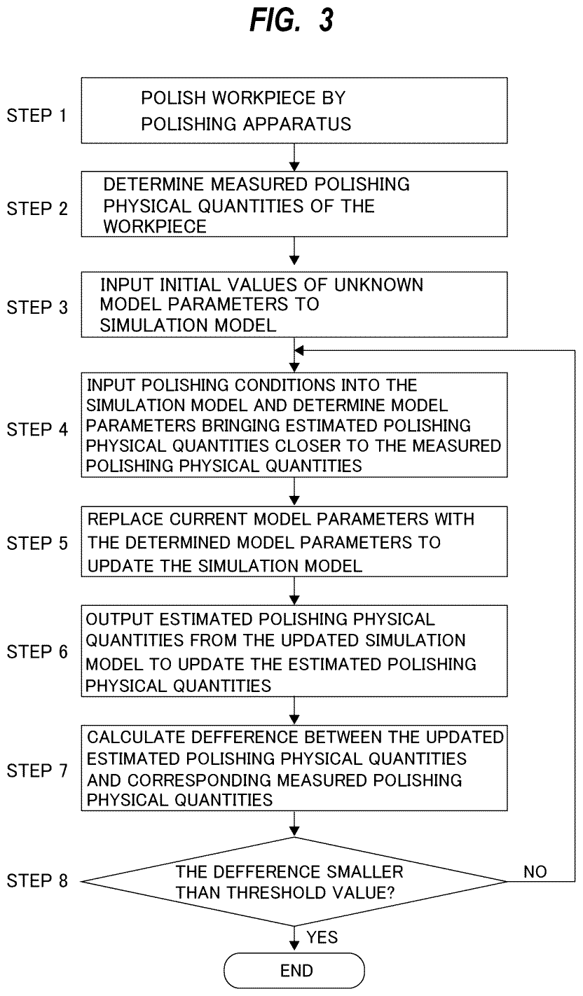

FIG. 3 is a flowchart illustrating a method of identifying the unknown model parameters of the simulation model.

In step 1, the polishing apparatus 1 shown in FIG. 1 polishes at least one workpiece under the predetermined polishing conditions.

In step 2, the arithmetic system 47 determines the measured polishing physical quantities from the measurement data obtained from the actual polishing of the workpiece. More specifically, the arithmetic system 47 calculates the measured polishing rate of the workpiece, and obtains the measured values of the various torques generated while the workpiece is being polished. The measured polishing rate can be calculated by dividing a difference between an initial film thickness of the workpiece and a film thickness of the polished workpiece by a polishing time. The measured values of the various torques may be the torque currents supplied to the polishing-head rotating motor 20, the table rotating motor 21, the polishing-head oscillation motor 22, the dresser oscillation motor 63, and the dresser rotating motor 60. These measured polishing physical quantities are stored in the memory 47a.

In step 3, the arithmetic system 47 inputs initial values of the unknown model parameters stored in the memory 47a to the simulation model.

In step 4, the arithmetic system 47 inputs the polishing conditions for the workpiece into the simulation model, and determines the model parameters that bring the estimated polishing physical quantities of the workpiece closer to the measured polishing physical quantities obtained in the step 2. This step 4 is a process of identifying or determining the unknown model parameters capable of bringing the estimated polishing physical quantities closer to the measured polishing physical quantities.

In step 5, the arithmetic system 47 replaces the current model parameters of the simulation model with the model parameters determined in the step 4 to update the simulation model.

In step 6, the arithmetic system 47 inputs the polishing conditions used in the step 4 into the updated simulation model, and outputs the estimated polishing physical quantities from the simulation model to update the estimated polishing physical quantities.

In step 7, the arithmetic system 47 calculates a difference between the updated estimated polishing physical quantities and the corresponding measured polishing physical quantities.

In step 8, the arithmetic system 47 evaluates the above difference. The steps 5 to 8 are a process of evaluating the determined model parameters. If the difference is greater than or equal to a predetermined threshold value, the arithmetic system 47 repeats the steps 4 to 8. When the above difference is smaller than the threshold value, the arithmetic system 47 terminates the determining operations for the model parameters. In one embodiment, the arithmetic system 47 counts the number of repetitions from the step 4 to the step 8 and if the number of repetitions is equal to or greater than a predetermined value (or a calculation time for repeating the steps 4 to 8 is greater than or equal to a predetermined value), and/or if the above difference is less than the threshold value, the arithmetic system 47 terminates the determining operations for the model parameters.

The arithmetic system 47 determines the model parameters for bringing the estimated polishing physical quantities closer to the measured polishing physical quantities according to algorithms (e.g., least square method, steepest descent method, simplex method) included in the identification program stored in the memory 47a. Constraints can be given to a range of parameters to be identified according to an algorithm, such as constrained least squares method. The simulation model having the model parameters finally determined according to the flowchart shown in FIG. 3 is stored in the memory 47a.

Next, the simulation model will be described. As described above, the simulation model includes the polishing-rate model for calculating an estimated polishing rate of the workpiece W and the polishing-torque model for calculating an estimated value of torque generated due to the sliding resistance of the polishing pad 2.

The polishing-rate model is expressed, for example, based on Preston law as follows.

$$Polishing rate MRR = {k}_{p} p \vert V \vert = ( {β}_{1} {}^{w} μ + {β}_{0} ) p \vert V \vert \qquad ( 1 )$$

where kₚ is Preston coefficient, p is pressure of the workpiece W applied to the polishing pad 2, V is relative velocity between the workpiece W and the polishing pad 2, β₁ and β₀ are constants relating the coefficient of friction of the workpiece W to the Preston coefficient, and ^{W}μ is coefficient of friction of the workpiece W.

The above equation (1) is set on the assumption that the Preston coefficient kₚ is proportional to the coefficient of friction ^{W}μ of the workpiece W and that Preston coefficient kₚ is expressed by a linear function. In other words, it is assumed that the polishing rate MRR of the workpiece W correlates with the coefficient of friction ^{W}μ of the workpiece W.

In the above equation (1), the constants β₁ and β₀ and the coefficient of friction ^{W}μ are unknown model parameters, while the pressure p and the relative velocity V are known model parameters given by the polishing conditions. Therefore, once the constants β₁ and β₀ and the coefficient of friction ^{W}μ are determined, the estimated value of the polishing rate, i.e., the estimated polishing rate, can be determined from the above equation (1).

Next, the polishing-torque model will be described. The polishing-torque model is a physical model for calculating an estimated value of mechanical torque required for the polishing apparatus during polishing of the workpiece W. During polishing of the workpiece W, sliding resistances act on the polishing surface 2a of the polishing pad 2. One of the sliding resistances is a sliding resistance generated between the polishing head 7 (including the workpiece W) and the polishing pad 2, and the other is a sliding resistance generated between the dresser 50 and the polishing pad 2. Depending on these sliding resistances, the torques required to rotate the polishing head 1, the polishing pad 2, and the dresser 50 at their respective set speeds change.

The polishing-torque model includes at least a head-rotation torque model configured to calculate an estimated value of a polishing-head rotation torque for rotating the polishing head 7 and the workpiece W on the polishing pad 2 about the axis of the polishing head 7 (this axis corresponds to an axis of the polishing-head shaft 18), and a pad-rotation torque model configured to calculate an estimated value of a polishing-pad rotation torque for rotating the polishing pad 2 about its axis (which corresponds to an axis of the table shaft 5a).

During polishing of the workpiece W, the workpiece W and the retainer ring 72 are pressed against the polishing pad 2 while the polishing head 7 and the workpiece W are rotating. The head-rotation torque model is a physical model for calculating an estimated value of the torque required for rotating the polishing head 7 about its axis at a predetermined speed against both the friction between the retainer ring 72 and the polishing pad 2 and the friction between the workpiece W and the polishing pad 2.

In this embodiment, dressing of the polishing surface 2a of the polishing pad 2 is performed during polishing of the workpiece W. Therefore, during polishing of the workpiece W, the retainer ring 72 of the polishing head 7, the workpiece W, and the dresser 50 are in contact with the polishing pad 2. As a result, the polishing-pad rotation torque depends on the frictions of the retainer ring 72, the workpiece W, and the dresser 50 with respect to the polishing pad 2. The pad-rotation torque model is a physical model for calculating an estimated value of the torque required to rotate the polishing pad 2 (i.e., the polishing table 5) at a predetermined speed against the friction between the retainer ring 72 and the polishing pad 2, the friction between the workpiece W and the polishing pad 2, and the friction between the dresser 50 and the polishing pad 2.

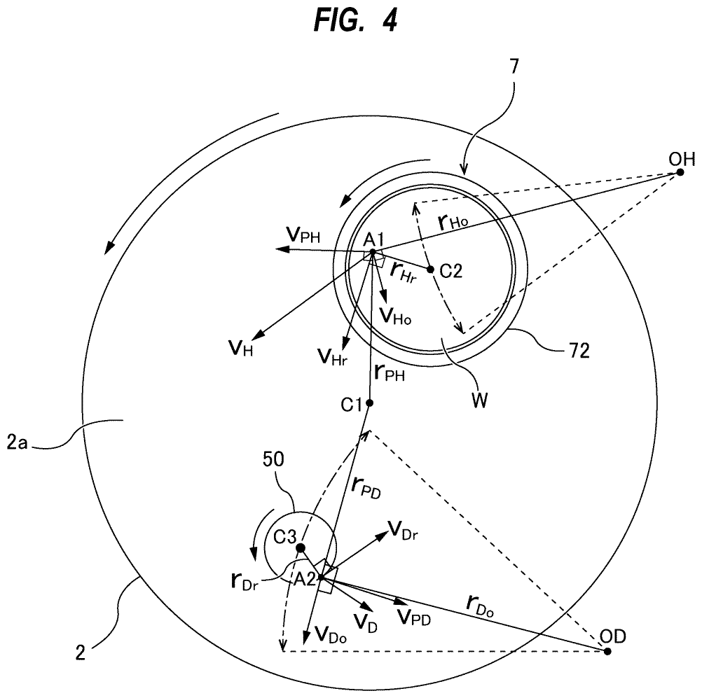

FIG. 4 is a schematic diagram showing velocity vectors on the polishing head 7, the workpiece W, and the dresser 50 on the polishing pad 2. Symbols shown in FIG. 4 are defined as follows.
Velocity vector in the rotating direction of the polishing pad 2 at a point A1 on the workpiece W or retainer ring 72: V_{PH}
Position vector from a center C1 of the polishing pad 2 to the point A1: r_{PH}
Position vector from a center C2 of the polishing head 7 to the point A1: r_{Hr}
Velocity vector in the rotating direction of the polishing head 7 at the point A1: V_{Hr}
Velocity vector in the oscillating direction of the polishing head 7 at the point A1: V_{Ho}
Composite velocity vector of the polishing head 7 at the point A1: V_{H}=V_{Hr}+V_{Ho}
Oscillation axis of the polishing head 7: OH (corresponds to the axis of the support shaft 14)
Position vector from the oscillation axis OH of the polishing head 7 to the point A1: r_{Ho}

Velocity vector in the rotating direction of the polishing pad 2 at a point A2 on the dresser 50: V_{PD}
Position vector from the center C1 of the polishing pad 2 to the point A2: r_{PD}
Position vector from a center C3 of the dresser 50 to the point A2: r_{Dr}
Velocity vector in the rotating direction of the dresser 50 at the point A2: V_{Dr}
Velocity vector in the oscillating direction of the dresser 50 at the point A2: V_{Do}
Composite velocity vector of the dresser 50 at the point A2: V_{D}=V_{Dr}+V_{Do}
Oscillation axis of the dresser 50: OD (corresponds to the axis of the support shaft 58)
Position vector from the oscillation axis OD of the dresser 50 to the point A2: r_{Do}

Relative velocity vector of the polishing head 7 with respect to the polishing pad 2 at the point A1: V_{PH-H}=V_{H}−V_{PH}
Unit vector of the relative velocity vector V_{PH-H}: uV_{PH-H}=V_{PH-H}/|V_{PH-H}|
Relative velocity vector of the polishing pad 2 with respect to the polishing head 7 at the point A1: V_{H-PH}=V_{PH}−V_{H}
Unit vector of the relative velocity vector V_{H-PH}: uV_{H-PH}=V_{H-PH}/|V_{H-PH}|
Relative velocity vector of the dresser 50 with respect to the polishing pad 2 at the point A2: V_{PD-D}=V_{D}−V_{PD}
Relative velocity vector V_{PD-D} unit vector: uV_{PD-D}=V_{PD-D}/|V_{PD-D}|
Relative velocity vector of the polishing pad 2 with respect to the dresser 50 at the point A2: V_{D-PD}=V_{PD}-V_{D}
Unit vector of the relative velocity vector V_{D-PD}: uV_{D-PD}=V_{D-PD}/|V_{D-PD}|

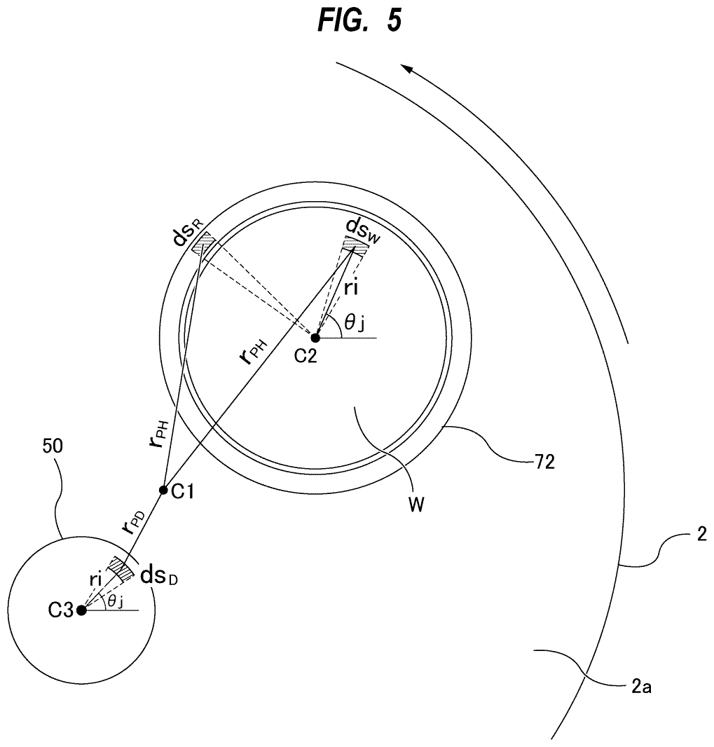

Next, the pad-rotation torque model will be described with reference to FIG. 5.

A sliding resistance dF_{PW} (representing a vector) acting between a minute area ds_{W} of the workpiece W and the polishing pad 2 is determined as follows.

$$Sliding resistance {dF}_{PW} = {}^{W} {μ}^{W} {pds}_{W} {uV}_{PH - H} \qquad ( 2 )$$

where ^{W}μ is coefficient of friction of the workpiece W, ^{W}p is pressure of the workpiece W applied to the polishing pad 2, ds_{W} is the minute area of the workpiece W, and uV_{PH-H} is the unit vector of the relative velocity vector of the polishing head 7 with respect to the polishing pad 2.

A sliding resistance dF_{PR} (representing a vector) acting between a minute area ds_{R} of the retainer ring 72 and the polishing pad 2 is determined as follows.

$$Sliding resistance {dF}_{PR} = {}^{R} {μ}^{R} {pds}_{R} {uV}_{PH - H} \qquad ( 3 )$$

where ^{R}μ is coefficient of friction of the retainer ring 72, ^{R}p is pressure of the retainer ring 72 applied to the polishing pad 2, ds_{R} is the minute area of the retainer ring 72, and uV_{PH-H} is the unit vector of the relative velocity vector of the polishing head 7 with respect to the polishing pad 2.

A sliding resistance dF_{PD} (representing a vector) acting between a minute area ds_{D} of the dresser 50 and the polishing pad 2 is determined as follows.

$$Sliding resistance {dF}_{PD} = {}^{D} {μ}^{D} {pds}_{D} {uV}_{PD - D} \qquad ( 4 )$$

where ^{D}μ is coefficient of friction of the dresser 50, ^{D}p is pressure of the dresser 50 applied to the polishing pad 2, ds_{D} is the minute area of the dresser 50, and uV_{PD-D} is the unit vector of the relative velocity vector of the dresser 50 with respect to the polishing pad 2.

Minute torques acting on the center C1 of the polishing pad 2 due to the sliding resistances in the minute area ds_{W} of the workpiece W, the minute area ds_{R} of the retainer ring 72, and the minute area ds_{D} of the dresser 50 are as follows.

$$Minute torques {dN}_{PW} = {r}_{PH} \times {dF}_{PW} \qquad ( 5 )$$

$${dN}_{PR} = {r}_{PH} \times {dF}_{PR} \qquad ( 6 )$$

$${dN}_{PD} = {r}_{PD} \times {dF}_{PD} \qquad ( 7 )$$

where the symbol x represents the cross product of the vectors.

When the position of the minute area ds_{W} of the workpiece W, the position of the minute area ds_{R} of the retainer ring 72, and the position of the minute area ds_{D} of the dresser 50 are expressed in polar coordinates (ri, θj), the pad-rotation torque model for calculating the estimated value of the polishing-pad rotation torque is given as follows.

$$Polishing - pad rotation torque {}^{P} N = {\sum }_{i} {\sum }_{j} {dN}_{PW} + {\sum }_{i} {\sum }_{j} {dN}_{PR} + {\sum }_{i} {\sum }_{j} {dN}_{PD} \qquad ( 8 )$$

In a case where the dressing of the polishing surface 2a of the polishing pad 2 is not performed during the polishing of the workpiece W, the term of ΣᵢτⱼdN_{PD} in the above equation (8) is 0.

Next, the head-rotation torque model for calculating an estimated value of the polishing-head rotation torque will be described.

The relative velocity vector of the polishing pad 2 with respect to the polishing head 7 is V_{H-PH}=V_{PH}−V_{H}, and the unit vector of the relative velocity vector V_{H-PH} is uV_{H-PH}=V_{H-PH}/|V_{H-PH}|.

Assuming that the workpiece W rotates at the same rotation speed [min⁻¹] as the polishing head 7, the sliding resistances acting on the minute area ds_{W} of the workpiece W and the minute area ds_{R} of the retainer ring 72 are expressed as follows.

$$Sliding resistances {dF}_{HW} = {}^{W} {μ}^{W} {pds}_{W} {uV}_{H - PH} \qquad ( 9 )$$

$${dF}_{HR} = {}^{R} {μ}^{R} {pds}_{R} {uV}_{H - PH} \qquad ( 10 )$$

Minute torques acting on the center C2 of the polishing head 7 due to the sliding resistances in the minute area ds_{W} of the workpiece W and the minute area ds_{R} of the retainer ring 72 are as follows.

$$Minute torques {dN}_{HrW} = {r}_{Hr} \times {dF}_{HW} \qquad ( 11 )$$

$${dN}_{HrR} = {r}_{Hr} \times {dF}_{HR} \qquad ( 12 )$$

where r_{Hr} is position vector from the center C2 of the polishing head 7 to the minute area ds_{W} of the workpiece W, and is also position vector from the center C2 of the polishing head 7 to the minute area ds_{R} of the retainer ring 72.

When the position of the minute area ds_{W} of the workpiece W and the position of the minute area ds_{R} of the retainer ring 72 are expressed in polar coordinates (ri, θj), the head-rotation torque model for calculating an estimated value of the polishing-head rotation torque is given as follows.

$$Polishing - head rotation torque {}_{r}^{H} N = {Σ}_{i} {Σ}_{j} {dN}_{HrW} + {Σ}_{i} {Σ}_{j} {dN}_{HrR} \qquad ( 13 )$$

In the present embodiment, dressing of the polishing surface 2a of the polishing pad 2 is performed during polishing of the workpiece W. Therefore, as shown in the above equation (8), the pad-rotation torque model includes the torque due to the sliding resistance of the dresser 50. In addition to the head-rotation torque model and the pad-rotation torque model, the polishing-torque model further includes a dresser rotation torque model configured to calculate an estimated value of the dresser rotation torque for rotating the dresser 50 on the polishing pad 2 about the axis of the dresser 50. The dresser rotation torque model is a physical model for calculating an estimated value of the torque required to rotate the dresser 50 at a predetermined speed against the friction between the dresser 50 and the polishing pad 2.

The dresser rotation torque model for calculating an estimated value of the dresser rotation torque is given in the same manner as the head-rotation torque model as follows.

$$Sliding resistance {dF}_{D} = {}^{D} {μ}^{D} p {ds}_{D} {uV}_{D - PD} \qquad ( 14 )$$

$$Minute torque {dN}_{rD} = {r}_{Dr} \times {dF}_{D} \qquad ( 15 )$$

$$Dresser rotation torque {}_{r}^{D} N = {Σ}_{i} {Σ}_{j} {dN}_{rD} \qquad ( 16 )$$

where ^{D}μ is coefficient of friction of the dresser 50, ^{D}p is pressure of the dresser 50 applied to the polishing pad 2, uV_{D-PD} is the unit vector of the relative velocity vector of the polishing pad 2 with respect to the dresser 50, and r_{Dr} is the position vector from the center C3 of the dresser 50 to the minute area ds_{D} of the dresser 50.

During dressing of the polishing pad 2, the dresser 50 oscillates on the polishing pad 2 in the radial direction of the polishing pad 2. The polishing-torque model further includes a dresser-oscillation torque model for calculating an estimated value of a dresser oscillation torque around the oscillation axis OD of the dresser 50 required for the oscillation of the dresser 50.

The dresser-oscillation torque model is expressed by the following equation (18).

$$Minute torque {dN}_{oD} = {r}_{Do} \times {dF}_{D} \qquad ( 17 )$$

$$Dresser oscillation torque {}_{o}^{D} N = {Σ}_{i} {Σ}_{j} {dN}_{oD} \qquad ( 18 )$$

where r_{Do} is position vector from the oscillation axis OD of the dresser 50 (see FIG. 4) to the minute area ds_{D} of the dresser 50.

In the present embodiment, the polishing head 7 oscillates on the polishing pad 2 during polishing of the workpiece W. The polishing-torque model further includes a head oscillation torque model for calculating an estimated value of a polishing-head oscillation torque around the oscillation axis OH of the polishing head 7 required for the oscillation of the polishing head 7.

The head oscillation torque model is expressed by the following equation (21).

$$Minute torques {dN}_{HoW} = {r}_{Ho} \times {dF}_{HW} \qquad ( 19 )$$

$${dN}_{HoR} = {r}_{Ho} \times {dF}_{HR} \qquad ( 20 )$$

$$Polishing - head oscillation torque {}_{o}^{H} N = {Σ}_{i} {Σ}_{j} {dN}_{HoW} + {Σ}_{i} {Σ}_{j} {dN}_{HoR} \qquad ( 21 )$$

where r_{Ho} is position vector from the oscillation axis OH (see FIG. 4) of the polishing head 7 to the minute area ds_{W} of the workpiece W, and is also position vector from the oscillation axis OH to the minute area ds_{R} of the retainer ring 72.

In the present embodiment, the polishing-torque model includes the above equations (8), (13), (16), (18), and (21). In a case where the dressing of the polishing pad 2 is not performed during polishing of the workpiece W, the polishing-torque model does not include the dresser rotation torque model represented by the equation (16) and the dresser-oscillation torque model represented by the equation (18).

The coefficients of friction ^{W}μ, ^{R}μ, and ^{D}μ included in the above equations (1), (8), (13), (16), (18), and (21) constituting the simulation model are unknown model parameters. These unknown model parameters are identified or determined by the identification process described later.

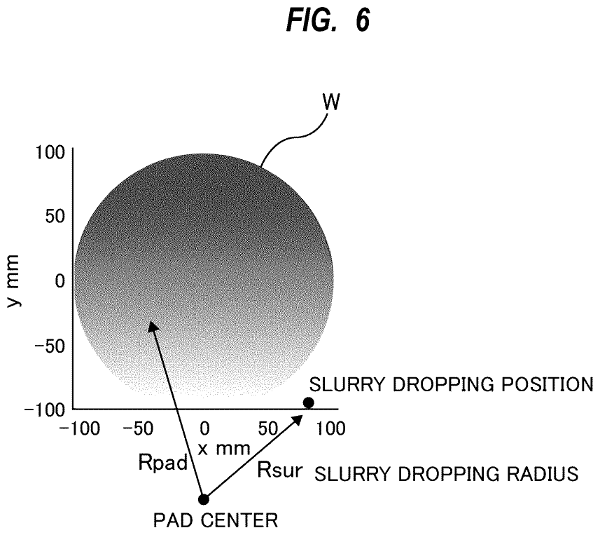

The coefficient of friction ^{W}μ of the workpiece W can vary depending on a distribution of the abrasive grains contained in the slurry supplied onto the polishing pad 2. The distribution of the coefficient of friction ^{W}μ of the workpiece W can be determined by calculation. Specifically, a basis function representing the coefficient of friction of the workpiece W is defined, and the torque and the polishing rate are simultaneously identified and calculated. As a result, the distribution of the coefficient of friction ^{W}μ of the workpiece W can be obtained as shown in FIG. 6.

Assuming that a polishing efficiency represented by the number of working abrasive grains on the workpiece W is proportional to the coefficient of friction ^{W}μ of the workpiece W, the distribution of the coefficient of friction ^{W}μ of the workpiece W can be replaced with the distribution of the working abrasive grains. The working abrasive grains are abrasive grains contained in the slurry that come into contact with the workpiece W and move relative to the workpiece W, thus contributing to the removal of the material of the workpiece W. As shown in FIG. 6, the coefficient of friction ^{W}μ is large at the same pad radius where the slurry is supplied to the workpiece W, and becomes smaller as the radial position is located outwardly. This is because, during polishing of the workpiece W, the slurry containing the abrasive grains is supplied from the slurry supply nozzle 8 (see FIG. 1) onto the polishing pad 2, and as the slurry moves toward the periphery of the workpiece W, the slurry is scattered outward due to the influence of centrifugal force. As can be seen from FIG. 1, the slurry supply nozzle 8 is located upstream of the polishing head 7 in the rotation direction of the polishing pad 2.

The coefficient of friction ^{W}μ at any position of radius r and angle θ on the surface of the workpiece W is given by the following equation.

$${}^{W} μ ( r , θ ) = ( \vert {R}_{pad} \vert - \vert {R}_{sur} \vert ) {}^{W} {μ}_{1} + {}^{W} {μ}_{0} \qquad ( 22 )$$

where Rpad is position vector of the position of radius r and angle θ, and Rsur is position vector of slurry supply position. Each vector originates from the center of rotation of the polishing pad. The symbols ^{W}μ₁ and ^{W}μ₀ are constants that relate the coefficient of friction to a difference between rotation radius of a position on the surface of the workpiece and rotation radius of the slurry supply position. In other words, the radius difference and the coefficient of friction are modeled as a linear function.

The above equation (22) is a physical model representing the distribution of the coefficient of friction ^{W}μ of the workpiece W. In the present embodiment, the simulation model further includes the physical model represented by the equation (22), in addition to the physical models represented by the above equations (1), (8), (13), (16), (18), and (21). The symbols ^{W}μ₁ and ^{W}μ₀ in the equation (22) are unknown model parameters.

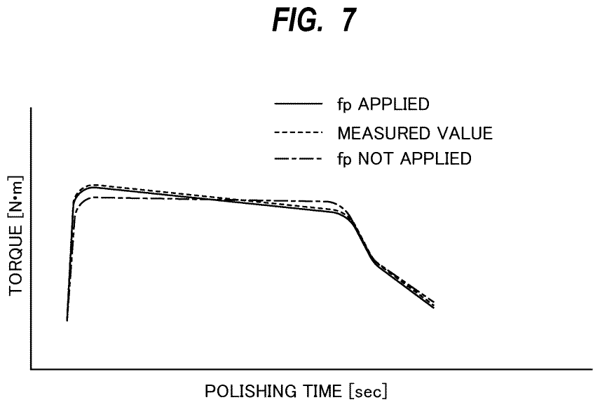

Next, an influence of deterioration of the polishing pad 2 with time on the coefficient of friction will be described. FIG. 7 is a graph showing a relationship between the torque of the polishing pad 2 and the polishing time. While the workpiece W is actually polished, the torque required to rotate the polishing pad 2 at a constant speed gradually decreases as shown by a dotted line in FIG. 7. Possible causes include a change in a surface roughness of the polishing pad 2, a change in a viscoelasticity of the polishing pad 2, a change in a thickness of the polishing pad 2, and a change in a temperature of the polishing pad 2.

In contrast, the torque of the polishing pad 2 calculated by the physical model represented by the above equation (8) is constant regardless of the polishing time as shown by an alternate long and short dash line in FIG. 7. Thus, in order to reflect the actual torque change of the polishing pad 2 in the simulation model, the simulation model further includes a mathematical model expressing that the polishing pad 2 deteriorates with a passage of a polishing time. In this embodiment, the deterioration of the polishing pad 2 is expressed as an initial rapid decrease and a subsequent gentle decrease in the coefficient of friction of the workpiece W.

The mathematical model function fₚ₁(t) representing the initial decrease in the coefficient of friction of the workpiece W is given as follows.

$${f}_{p 1} ( t ) = {}^{W} {μ}_{i} [ ( 1 - {α}_{1} ) exp [ - ( t - {t}_{0} ) / T ] + {α}_{1} ] \qquad ( 23 )$$

In the equation (23), t is polishing time, t₀ is start time of polishing, and T is a time constant.

The mathematical model function fₚ₂(t) representing the gentle decrease in the coefficient of friction of the workpiece W is given as follows.

$${f}_{p 2} ( t ) = {α}_{2} ( t - {t}_{0} ) + 1 \qquad ( 24 )$$

Using the product of the above mathematical model functions fₚ(t)=fₚ₁(t) fₚ₂(t), the coefficient of friction ^{W}μ of the workpiece W is obtained by the following equation.

$${}^{W} μ = {}^{W} {μ}_{i} {f}_{p} ( t ) \qquad ( 25 )$$

The above-mentioned mathematical model includes a fitting function fₚ(t) for reducing the coefficient of friction of the workpiece W with the passage of polishing time. This fitting function fₚ(t) is a function with the polishing time t as a variable. In the above equations, α₁, α₂, and T are unknown model parameters.

As discussed above, the simulation model of the present embodiment includes the physical models for calculating the estimated polishing rate of the workpiece W and the estimated torques of the polishing apparatus 1, and further includes the single mathematical model representing a decrease in the coefficient of friction of the workpiece W. As shown by a solid line in FIG. 7, the simulation model can calculate an estimated torque that changes in the same manner as the actual torque.

Next, a method of identifying (or determining) the above-mentioned unknown model parameters ^{R}μ, ^{D}μ, ^{W}μ₁, ^{W}μ₀, β₁, β₀, α₁, α₂, and T will be described. The arithmetic system 47 is configured to identify or determine the unknown model parameters of the simulation model by using the measured polishing physical quantities, obtained by actual polishing, as variables for identification. The arithmetic system 47 operates according to the instructions included in the identification program stored in the memory 47a, and uses algorithms (e.g., least square method, steepest descent method, simplex method, etc.) to determine the model parameters that bring the estimated polishing physical quantities closer to the measured polishing physical quantities.

As described below, in the present embodiment, the arithmetic system 47 is configured to determine the model parameters ^{W}μ₁, ^{W}μ₀, ^{R}μ, and ^{D}μ using the least square method, and determine the model parameters β₁, β₀, α₁, α₂, and T using the simplex method. It is noted, however, that the present invention is not limited to the present embodiment, and the unknown model parameters may be determined using another algorithm, such as the steepest descent method. Alternatively, the unknown model parameters may be determined using only the least square method.

In one embodiment, an integrated calculation model using the least square method is as follows. In the following equation, upper left letter P represents the polishing pad 2, upper left letter H represents the polishing head 7, upper left letter D represents the dresser 50, lower left letter r represents the rotation, and lower left letter o represents the oscillation.

$$[ \begin{matrix}{}_{r}^{P} N \\ {}_{xload}^{H} N \\ {}_{r}^{H} N \\ {}_{o}^{H} N\end{matrix} ] = [ \begin{matrix}{f}_{p} {}_{r}^{PW} {C}_{0} & {f}_{p} {}_{r}^{PW} {C}_{1} & {}_{r}^{PR} C \\ {f}_{p} {}^{xload} {C}_{0} & {f}_{p} {}^{xload} {C}_{1} & {}_{xload}^{PR} C \\ {f}_{p} {}_{r}^{W} {C}_{0} & {f}_{p} {}_{r}^{W} {C}_{1} & {}_{r}^{R} C \\ {f}_{p} {}_{o}^{W} {C}_{0} & {f}_{p} {}_{o}^{W} {C}_{1} & {}_{o}^{R} C\end{matrix} ] [ \begin{matrix}{}^{W} {μ}_{0} \\ {}^{W} {μ}_{1} \\ {}^{R} μ\end{matrix} ] + [ \begin{matrix}{}_{r}^{P} {N}_{fr} \\ {}_{xload}^{H} {N}_{fr} \\ {}_{r}^{H} {N}_{fr} \\ {}_{o}^{H} {N}_{fr}\end{matrix} ] \qquad ( 26 )$$

On the left side of the above equation (26), the measured polishing physical quantities obtained from the actual polishing of the workpiece are input. The unknown model parameters are determined using the least square method as follows. Specifically, the equation (26) is expanded, a term of a parameter X to be identified is extracted, and an equation Y=AX is created. Further, the parameter X is identified by the least square method from an equation X=A*Y using a pseudo-inverse matrix A* of a matrix A. By repeating these operations, all unknown parameters can be identified.

The left side of the equation (26) is measurement data Yexp obtained from the actual polishing, and the right side is estimated data Ysim obtained from the simulation model. The right side Ysim is a product AX of the matrix A on the left side, which can be calculated only by the inputted polishing conditions, and the vector X of the unknown parameters related to the friction on the right side. The arithmetic system 47 can determine the unknown parameters X=A*Yexp using the least square method and using the pseudo-inverse matrix A* of the known matrix A.

In one embodiment, an error function model using the simplex method is as follows.

$$Error ( {β}_{1} , {β}_{0} , {α}_{1} , {α}_{2} , T ) = {\sum }_{k = 1}^{{N}_{k}} {[ \begin{matrix}‖ {}_{r}^{P} {N}_{k}^{exp} - {}_{r}^{P} {N}_{k}^{sim} ‖ \\ ‖ {}_{r}^{H} {N}_{k}^{exp} - {}_{r}^{H} {N}_{k}^{sim} ‖ \\ ‖ {}_{o}^{H} {N}_{k}^{exp} - {}_{o}^{H} {N}_{k}^{sim} ‖ \\ ‖ {MRR}_{k}^{exp} - {MRR}_{k}^{sim} ‖\end{matrix} ]}^{T} [ \begin{matrix}{w}_{1} \\ {w}_{2} \\ {w}_{3} \\ {w}_{4}\end{matrix} ] \qquad ( 27 )$$

In the above equation (27), numerical values with subscript exp represent the measured values of the torques and the polishing rate. Numerical values with subscript sim are estimated values obtained from the simulation model. Symbols w₁, w₂, w₃, w₄ represent weights for estimation errors of the respective physical quantities.

The arithmetic system 47 operates according to the identification program to identify the above-described unknown model parameters. The arithmetic system 47 replaces the current model parameters of the simulation model with the determined model parameters. The arithmetic system 47 inputs the polishing conditions for the workpiece into the simulation model containing the determined model parameters, and calculates the estimated polishing physical quantities.

Further, the arithmetic system 47 calculates a difference between the measured polishing physical quantities and the estimated polishing physical quantities, and determines whether or not this difference is smaller than a predetermined threshold value. If the difference is greater than or equal to the threshold value, the arithmetic system 47 performs the above-discussed identification again using measured polishing physical quantities of another workpiece. If the difference is less than the threshold value, the arithmetic system 47 calculates estimated polishing physical quantities of another workpiece using the simulation model containing the determined model parameters. Specifically, the arithmetic system 47 inputs polishing conditions for a workpiece (e.g., a wafer), which has not been polished yet, into the simulation model, and can accurately calculate an estimated polishing rate of that workpiece using the simulation model.

The arithmetic system 47 transmits the estimated polishing rate to the operation controller 80 shown in FIG. 1. The operation controller 80 can estimate a polishing end point of the workpiece being polished based on the estimated polishing rate. Further, the operation controller 80 may create a distribution of estimated polishing rates of the workpiece during polishing of the workpiece, and may control polishing pressures on the workpiece being polished (i.e., pressures applied from the polishing head 7 to the workpiece) based on the distribution of the estimated polishing rates.

Next, an embodiment of polishing a workpiece using the above-mentioned chemical mechanical polishing system will be described. The chemical mechanical polishing system described below is configured to obtain the measured polishing physical quantities (e.g., the measured polishing rate of the workpiece and the measured value of the torque) during or after polishing of the workpiece, calculate an estimated polishing rate of the next workpiece, and determine polishing conditions for the next workpiece based on the estimated polishing rate.

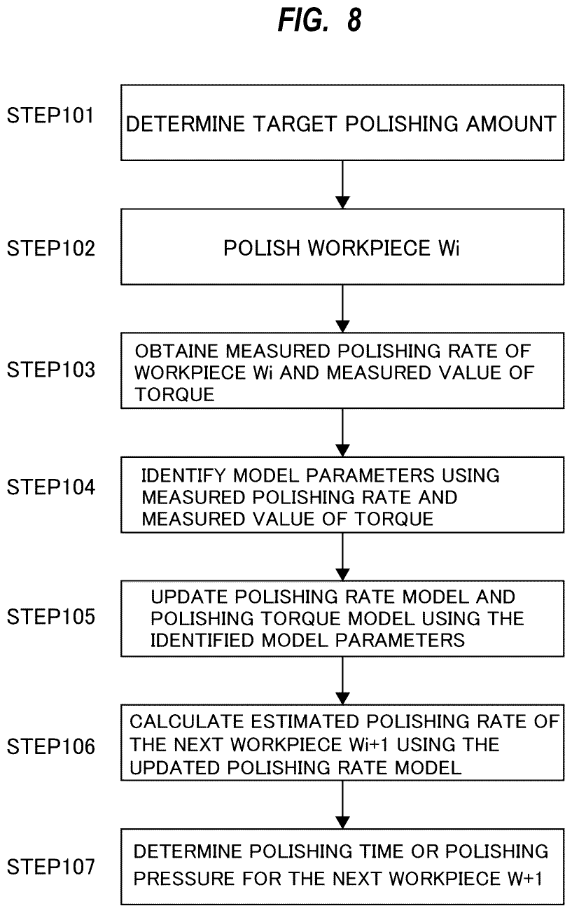

FIG. 8 is a flow chart illustrating an embodiment for polishing a workpiece using the chemical mechanical polishing system.

In step 101, the arithmetic system 47 determines a target removal amount. The target removal amount is a difference between an initial film thickness of the workpiece and a target film thickness. In one example, the initial film thickness is measured by the film-thickness sensor 49 shown in FIG. 1. The target film thickness is input in advance to the arithmetic system 47 before polishing of the workpiece begins.

In step 102, the polishing apparatus 1 chemically-mechanically polishes the workpiece Wi.

In step 103, the arithmetic system 47 acquires measured polishing physical quantities (e.g., the measured polishing rate of the workpiece Wi and the measured value of the torque) during or after polishing of the workpiece Wi. In one embodiment, the measured polishing physical quantities include a measured value of the polishing-pad rotation torque, a measured value of the polishing-head rotation torque, a measured value of the polishing-head oscillation torque, a measured value of the dresser oscillation torque, and the measured polishing rate of the workpiece Wi during polishing of the workpiece Wi.

In step 104, the arithmetic system 47 uses the measured polishing physical quantities obtained from polishing of the workpiece Wi as variables for identification to identify the unknown model parameters of the polishing rate model and polishing torque models. Specifically, the arithmetic system 47 identifies (determines) the unknown model parameters ^{R}μ, ^{D}μ, ^{W}μ₁, ^{W}μ₀, β₁, β₀, α₁, α₂, and T by using the above the identification equations (26) and (27).

In step 105, the arithmetic system 47 updates the polishing rate model and the polishing torque models by substituting the model parameters determined in the step 104 into the polishing rate model expressed by the above equation (1) and the polishing torque models expressed by the above equations (8), (13), (18), and (21). The polishing rate model expressed by the above equation (1) and the polishing torque models expressed by the above equations (8), (13), (18), and (21) are stored in advance in the memory 47a of the arithmetic system 47.

The equation (1) is the polishing rate model for calculating a polishing rate of the workpiece, the equation (8) is the pad-rotation torque model for calculating an estimated value of the polishing-pad rotation torque, the equation (13) is the head-rotation torque model for calculating an estimated value of the polishing-head rotation torque, the equation (18) is the dresser-oscillation torque model for calculating an estimated value of the dresser oscillation torque, and the equation (21) is the head-oscillation torque model for calculating an estimated value of the polishing-head oscillation torque.

In step 106, the arithmetic system 47 calculates an estimated polishing rate of the next workpiece Wi+1 to be polished using the polishing rate model expressed by the following equation (1)′.

$$Estimated polishing rate MRR = {k}_{p} p \vert V \vert = ( {β}_{1} {}^{W} μ + {β}_{0} ) {p}_{i + 1} \vert {V}_{i + 1} \vert \qquad {( 1 )}^{′}$$

where kp is the Preston coefficient, pi+1 is polishing pressure of the workpiece Wi+1 to be polished next against the polishing pad 2, Vi+1 is relative speed between the workpiece Wi+1 and the polishing pad 2, β₁ and β₀ are constants relating the coefficient of friction of workpiece to the Preston coefficient, and ^{W}μ is the coefficient of friction of the workpiece Wi. The symbols β₁, β₀, and ^{W}μ are model parameters determined in the step 104, and the above equation (1)′ is the polishing rate model updated in the step 105.

In step 107, the arithmetic system 47 determines a polishing time or a polishing pressure pᵢ₊₁ as the polishing conditions for the workpiece Wi+1 to be polished next. In one embodiment, the polishing time for the workpiece Wi+1 to be polished next is determined by the arithmetic system 47 as follows. Specifically, the arithmetic system 47 calculates a polishing amount of the workpiece Wi from the measured polishing rate and the polishing time of the workpiece Wi, calculates a difference between a target polishing amount of the workpiece Wi+1 to be polished next and the polishing amount of the workpiece Wi, and calculates the polishing time for the next workpiece Wi+1 based on the calculated difference and the measured polishing rate of the workpiece Wi. In another embodiment, the arithmetic system 47 may calculate the polishing time for the next workpiece Wi+1 based on the measured polishing rate of the workpiece Wi and the target polishing amount of the workpiece Wi+1 to be polished next.

In one embodiment, the polishing pressure pi+1 for the workpiece Wi+1 to be polished next is determined by the arithmetic system 47 as follows. Specifically, the arithmetic system 47 calculates a response rate of polishing rate per unit polishing pressure (polishing rate/polishing pressure) from polishing pressure data obtained in polishing of the workpiece Wi and the measured polishing rate of the workpiece Wi, and calculates polishing pressure pi+1 for the next workpiece Wi+1 based on the calculated response rate, the target polishing amount of the workpiece Wi+1 to be polished next, and the polishing time of the workpiece Wi.

The polishing time or polishing pressure pi+1 determined in the step 107 above is applied to polishing of the next workpiece Wi+1 and is used as the polishing conditions for polishing the workpiece Wi+1.

The steps 102 to 107 may be repeated each time one workpiece is polished, or may be repeated each time multiple workpieces are polished. For example, the steps 102-107 are repeated each time a predetermined number of workpieces are polished.

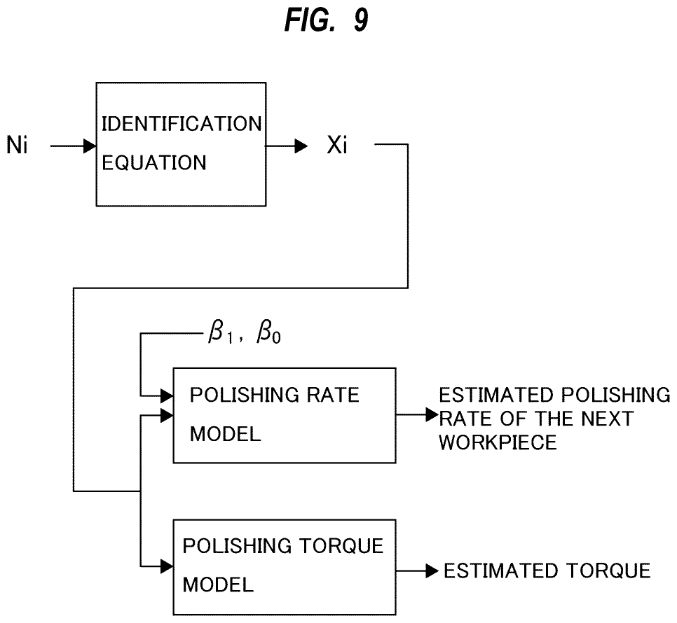

FIG. 9 is a block diagram for explaining an embodiment of the identification of the model parameters and the calculation of the estimated polishing rate. The arithmetic system 47 acquires the measured polishing physical quantities Ni including the measured values of torques and the measured polishing rate during or after polishing of the workpiece Wi, and inputs the measured polishing physical quantities Ni as variables for identification into the identification equations (26) and (27). The arithmetic system 47 operates according to the identification program to identify (determine) the model parameters Xi (^{R}μ, ^{D}μ, ^{W}μ₁, ^{W}μ₀, β₁, β₀, α₁, α₂, T) using the identification equations (26) and (27).

The arithmetic system 47 substitutes the model parameters Xi into the polishing rate model and the polishing torque models to update the polishing rate model and the polishing torque models. The arithmetic system 47 inputs the polishing conditions for the next workpiece Wi+1 (e.g., the pressure of the polishing head 7 against the polishing pad 2, the rotational speed of the polishing head 7, the rotational speed of the polishing pad 2, the rotational speed of the dresser 50, the pressure of the dresser 50 against the polishing pad 2, etc.) into the polishing rate model and the polishing torque models to calculate an estimated polishing rate of the next workpiece Wi+1 and estimated torques.

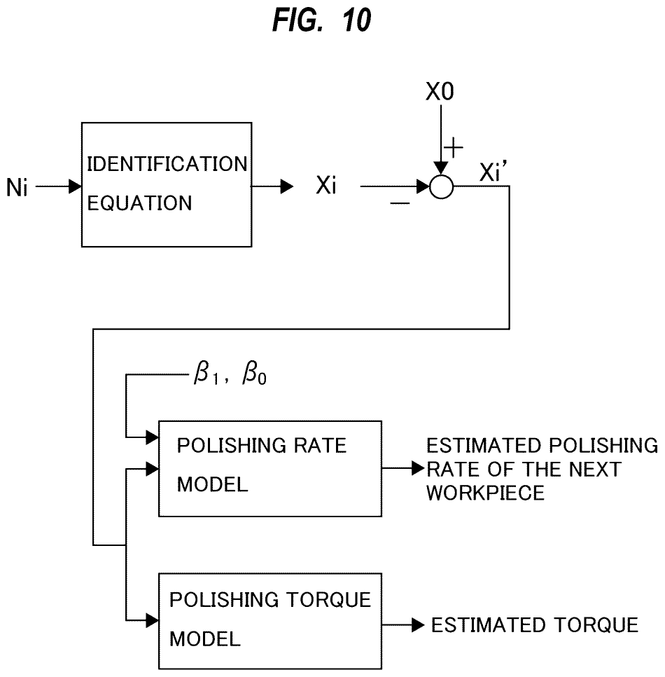

FIG. 10 is a block diagram illustrating another embodiment of the identification of the model parameters and the calculation of the estimated polishing rate. The basic processes of this embodiment are the same as those of the embodiment shown in FIG. 9, but this embodiment is different in that the identified (determined) model parameters Xi are corrected using predetermined reference model parameters X0.

The reference model parameters X0 are identified in the same manner as the model parameters Xi before polishing of a workpiece is started using the polishing apparatus 1. In one embodiment, the reference model parameters X0 are identified (determined) using measured polishing physical quantities including a measured polishing rate of a sample and measured values of the torques obtained in polishing of the sample with the polishing apparatus 1 in an initial state that has not yet been used to polish any workpiece. The reference model parameters X0 are stored in the memory 47a of the arithmetic system 47.

As shown in FIG. 10, the arithmetic system 47 determines the model parameters Xi using the measured polishing physical quantities Ni including the measured polishing rate and the measured values of the torques obtained from polishing of the workpiece Wi, calculates differences Xi′ between the reference model parameters X0 and the model parameters Xi by subtracting the model parameters Xi from the reference model parameters X0, and updates the polishing rate model and the polishing torque models by substituting the calculated differences Xi′ as corrected model parameters into the polishing rate model and the polishing torque models. The arithmetic system 47 inputs the polishing conditions for the next workpiece Wi+1 into the polishing rate model and the polishing torque models to calculate the estimated polishing rate of the next workpiece Wi+1 and the estimated torques.

According to this embodiment, noise that may be contained in the model parameters Xi can be removed by the correction.

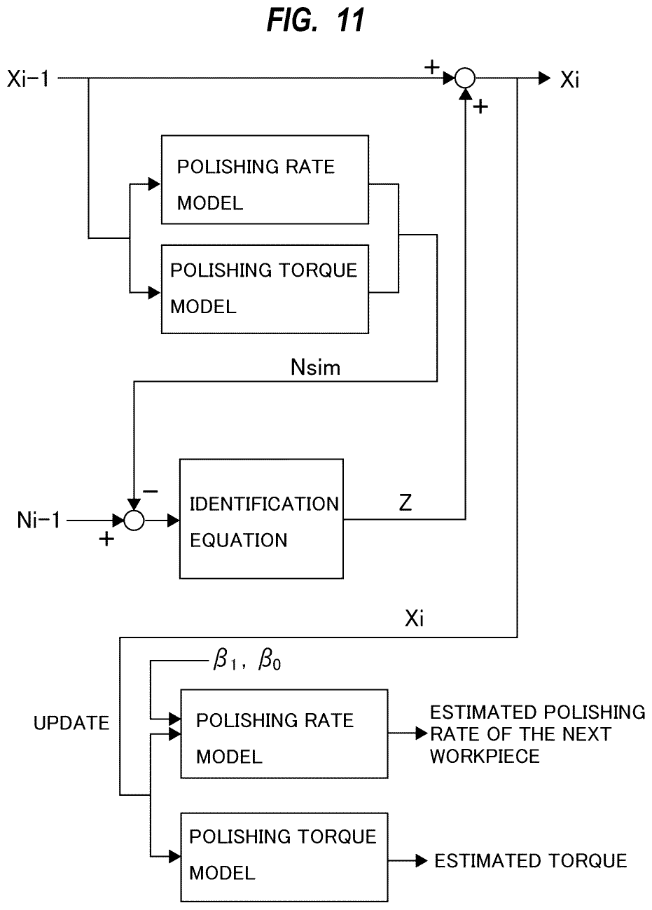

FIG. 11 is a block diagram for explaining yet another embodiment of the identification of the model parameters and the calculation of the estimated polishing rate. The basic processes of this embodiment are the same as those of the embodiment shown in FIG. 9, but in this embodiment, the arithmetic system 47 is configured to calculate correction amount Z based on differences between estimated polishing physical quantities Nsim (including estimated polishing rate and estimated torques) obtained from polishing of a previous workpiece Wi−1 and measured polishing physical quantities Ni−1 (including measured polishing rate and measured values of the torques) obtained from polishing of the previous workpiece Wi−1, and to determine the model parameters Xi for the current workpiece Wi by adding the correction amount Z to the model parameters Xi−1 obtained from the polishing of the previous workpiece Wi−1.

The estimated polishing physical quantities Nsim includes the estimated polishing rate and the estimated torques obtained by inputting polishing conditions to the polishing rate model and the polishing torque models that have been updated based on the polishing result of the previous workpiece Wi−1.

The correction amount Z is determined as follows. The processing system 47 inputs, as variables for identification, the differences between the estimated polishing physical quantities Nsim obtained from polishing of the previous workpiece Wi−1 and the measured polishing physical quantities Ni−1 obtained from polishing of the previous workpiece Wi−1 into the identification equations (26) and (27), and calculates the correction amount Z using the identification equations (26) and (27) according to the identification program.

The arithmetic system 47 determines the model parameters Xi for the current workpiece Wi by adding the correction amount Z to the model parameters Xi−1 obtained from polishing of the previous workpiece Wi−1, and updates the polishing rate model and the polishing torque models by substituting the model parameters Xi into the polishing rate model and the polishing torque models. The arithmetic system 47 calculates the estimated polishing rate and the estimated torques for the next workpiece Wi+1 by inputting the polishing conditions into the updated polishing rate model and the polishing torque models.

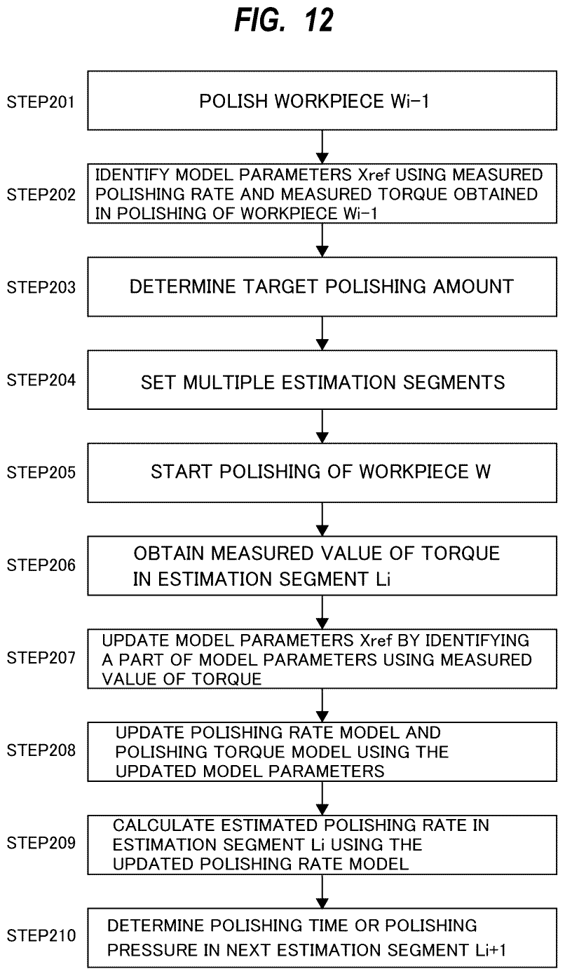

FIG. 12 is a flow chart for explaining another embodiment of polishing a workpiece using the chemical mechanical polishing system. In this embodiment, the model parameters of the simulation model are identified using variables for identification which are the measured polishing rate and the measured torques obtained in polishing of the previous workpiece Wi−1 performed before the polishing of the workpiece W, a plurality of estimation segments are set within the polishing time of the workpiece W, measured polishing physical quantities (including measured values of torques in one of the estimation segments) are obtained during polishing of the workpiece W, a part of the model parameters of the simulation model are identified using the measured polishing physical quantities as variables for identification to update the model parameters, and the polishing conditions are input to the simulation model, so that the estimated polishing rate of the workpiece in the one estimation segment is calculated.

In step 201, before polishing of the workpiece W, the polishing apparatus 1 performs chemical mechanical polishing of a workpiece Wi−1.

In step 202, the arithmetic system 47 identifies model parameters Xref of the polishing rate model and the polishing torque models by using, as variables for identification, a measured polishing rate and measured torques obtained in polishing of the previous workpiece Wi−1.

In step 203, the arithmetic system 47 determines a target polishing amount of the workpiece W. The target polishing amount is a difference between an initial film thickness of the workpiece W and the target film thickness. In one example, the initial film thickness is measured by the film-thickness sensor 49 shown in FIG. 1. The target film thickness is input in advance to the arithmetic system 47 before polishing of the workpiece W.

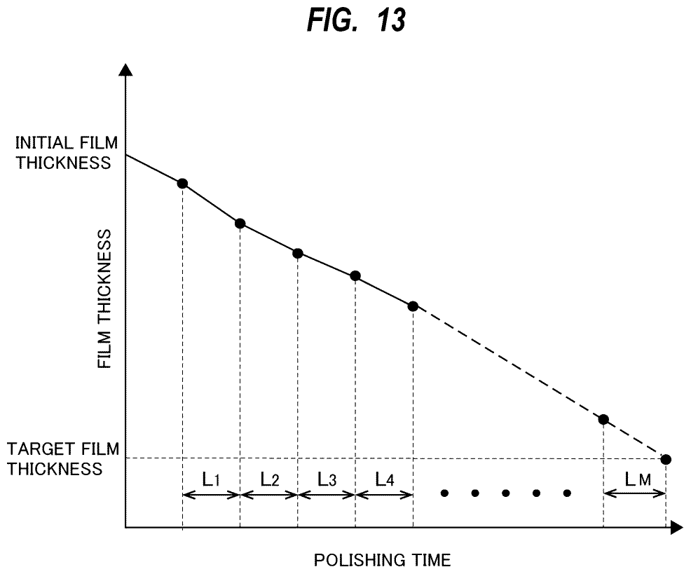

In step 204, the arithmetic system 47 sets a plurality of estimation segments L₁ to L_{M} within a polishing time of the workpiece W. FIG. 13 is a graph showing an example of the plurality of estimation segments L₁ to L_{M}. The plurality of estimation segments L₁ to L_{M} are set within the polishing time from the initial film thickness to the target film thickness of the workpiece to be polished. The plurality of estimation segments L₁ to L_{M} are continuous time sections (or continuous time segments) during polishing of one workpiece.

In step 205, the polishing apparatus 1 starts chemical mechanical polishing of the workpiece W.

In step 206, the arithmetic system 47 acquires measured polishing physical quantities including measured values of the torques in a current estimation segment Li during polishing of the workpiece W. In one embodiment, the measured polishing physical quantities include a measured value of the polishing-pad rotation torque, a measured value of the polishing-head rotation torque, a measured value of the polishing-head oscillation torque, and a measured value of the dresser oscillation torque during polishing of the workpiece W.

In step 207, the arithmetic system 47 identifies (or determines) some of the model parameters of the polishing rate model and the polishing torque models by using, as variables for identification, the measured polishing physical quantities including the measured values of the torques obtained from polishing of the workpiece W to thereby update the model parameters Xref. Specifically, the arithmetic system 47 identifies (or determines) some of the unknown model parameters ^{R}μ, ^{D}μ, Wμ₁, ^{W}μ₀, β₁, β₀, α₁, α₂, and T by using the above identification equations (26) and (27).

In step 208, the arithmetic system 47 updates the polishing rate model and the polishing torque models by substituting the model parameters Xref updated in the step 207 into the polishing rate model expressed by the above equation (1) and the polishing torque models expressed by the above equations (8), (13), (18), and (21). The polishing rate model expressed by the above equation (1) and the polishing torque models expressed by the above equations (8), (13), (18), and (21) are stored in advance in the memory 47a of the arithmetic system 47.

The equation (1) is the polishing rate model for calculating a polishing rate of a workpiece, the equation (8) is the pad-rotation torque model for calculating an estimated value of the polishing-pad rotation torque, the equation (13) is the head-rotation torque model for calculating an estimated value of the polishing-head rotation torque, the equation (18) is the dresser-oscillation torque model for calculating an estimated value of the dresser oscillation torque, and the equation the (21) is the head-oscillation torque model for calculating an estimated value of the polishing-head oscillation torque.

In step 209, the arithmetic system 47 calculates an estimated polishing rate of the workpiece W in the current estimation segment Li using the polishing rate model updated in the step 208.

In step 210, the arithmetic system 47 determines polishing time or polishing pressure pi+1 for the workpiece W in the next estimation segment Li+1. In one embodiment, the polishing time of the workpiece W in the next estimation segment Li+1 is determined by the arithmetic system 47 as follows. The arithmetic system 47 calculates the polishing amount of the workpiece W in the estimation segment Li from the estimated polishing rate and the polishing time of the workpiece W in the estimation segment Li, calculates a difference between the target polishing amount of the workpiece W in the next estimation segment Li+1 and the polishing amount in the estimation segment Li, and calculates the polishing time in the next estimation segment Li+1 based on the calculated difference and the estimated polishing rate of the workpiece W in the estimation segment Li. In another embodiment, the arithmetic system 47 may calculate the polishing time in the next estimation segment Li+1 based on the estimated polishing rate of the workpiece W in the estimation segment Li and the target polishing amount of the workpiece W in the next estimation segment Li+1.

In one embodiment, the polishing pressure pi+1 for the workpiece W in the next estimation segment Li+1 is determined by the arithmetic system 47 as follows. Specifically, the arithmetic system 47 calculates a response rate of polishing rate per unit polishing pressure (polishing rate/polishing pressure) from polishing pressure data obtained in polishing of the workpiece W in the estimation segment Li and the estimated polishing rate of the workpiece W in the estimation segment Li, and calculates the polishing pressure pi+1 for the workpiece W in the next estimation segment Li+1 based on the calculated response rate, the target polishing amount of the workpiece W in the next estimation segment Li+1, and the polishing time in the estimation segment Li.

The polishing time or polishing pressure pi+1 determined in the step 210 is applied to polishing of the workpiece W in the next estimation segment Li+1 and is used as the polishing conditions for polishing of the workpiece W.

The steps 206 to 209 may be performed once when the workpiece W is polished in the first estimation segment L1, or may be repeated each time one or more estimation segments have elapsed.

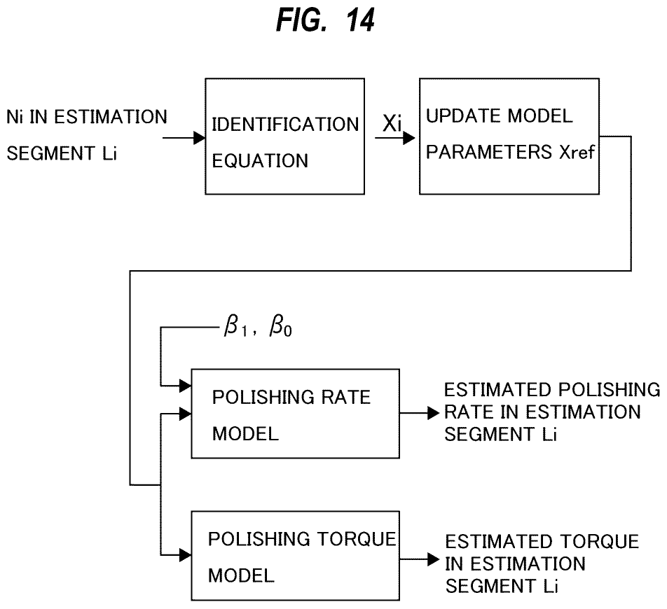

FIG. 14 is a block diagram for explaining one embodiment of identification for the model parameters and calculation of the estimated polishing rate. The measured values of torques, which are the measured polishing physical quantities Ni acquired in one estimation segment Li during polishing of the workpiece W, are input as variables for identification to the identification equations (26) and (27). The arithmetic system 47 operates according to the identification program to identify (or determine) a part of the model parameters using the identification equations (26) and (27), and obtains the model parameters Xi corresponding to the estimation segment Li. Furthermore, the arithmetic system 47 updates the model parameters Xref by replacing the model parameters Xref identified from the polishing result of the previous workpiece Wi−1 with the model parameters Xi.

The arithmetic system 47 substitutes the updated model parameters Xref into the polishing rate model and the polishing torque models to update the polishing rate model and the polishing torque models. The arithmetic system 47 inputs polishing conditions (e.g., the pressure of the polishing head 7 against the polishing pad 2, the rotational speed of the polishing head 7, the rotational speed of the polishing pad 2, the rotational speed of the dresser 50, the pressure of the dresser 50 against the polishing pad 2, etc.) into the polishing rate model and the polishing torque models to calculate an estimated polishing rate and estimated torques in the current estimation segment Li.

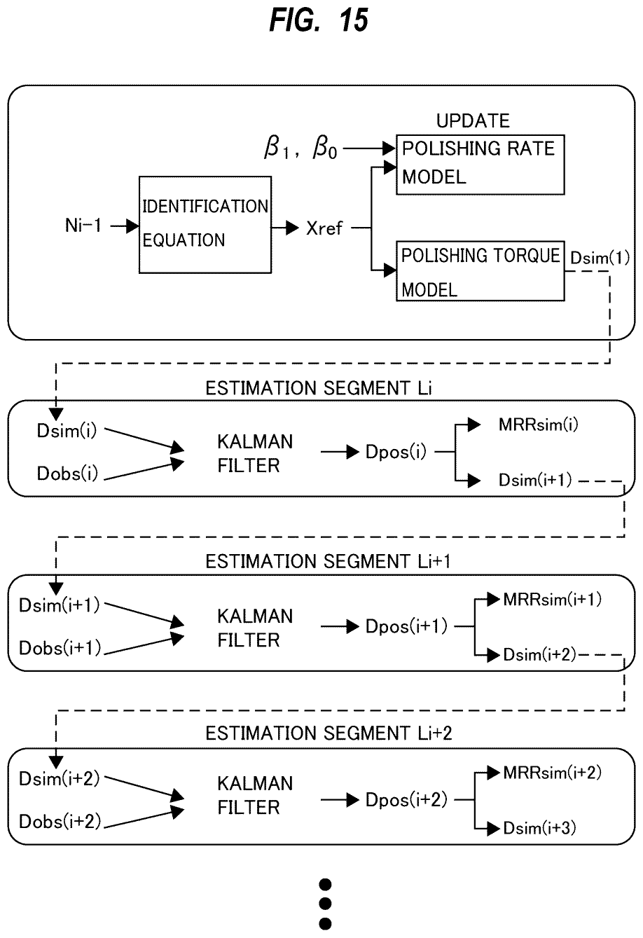

FIG. 15 is a block diagram for explaining yet another embodiment for polishing a workpiece using the chemical mechanical polishing system. Details of this embodiment that are not specifically explained are the same as those of the embodiments explained with reference to FIGS. 12 and 13, and therefore repeated explanations will be omitted.

In this embodiment, the arithmetic system 47 is configured to calculate post-estimated torques by applying a Kalman filter to estimated torques calculated using the polishing torque models in an estimation segment prior to the current estimation segment Li and measured values of the torques obtained in the estimation segment Li, update the model parameters of the simulation model by identifying a part of the model parameters using the measured polishing physical quantities including the post-estimated torques as variables for identification, and input the polishing conditions into the updated simulation model to thereby calculate the estimated polishing rate of the workpiece W in the estimation segment Li.

The arithmetic system 47 is configured to calculate estimated torques Dsim(i) in the current estimation segment Li from polishing of the workpiece W in the previous estimation segment, obtain measured values Dobs(i) of the torques in the current estimation segment Li, and apply the Kalman filter to the estimated torques Dsim(i) and the measured values Dobs(i) of the torques to calculate post-estimated torques Dpos(i) in the current estimation segment Li.

More specifically, as shown in FIG. 15, the arithmetic system 47 first identifies the model parameters Xref of the polishing rate model and the polishing torque models by using initial measurement data N−1 including measured polishing rate and measured torques obtained in polishing of a previous workpiece Wi−1. Specifically, the arithmetic system 47 inputs the initial measurement data N−1 to the identification equations (26) and (27) and identifies the model parameters Xref according to the identification program.

The arithmetic system 47 substitutes the model parameters Xref into the polishing rate model and the polishing torque models to update the polishing rate model and the polishing torque models. The arithmetic system 47 inputs the polishing conditions (e.g., the pressure of the polishing head 7 against the polishing pad 2, the rotational speed of the polishing head 7, the rotational speed of the polishing pad 2, the rotational speed of the dresser 50, the pressure of the dresser 50 against the polishing pad 2, etc.) into the updated polishing torque models to calculate estimated torques Dsim (1) in an initial estimation segment L1.

After the estimation segment L1, the arithmetic system 47 repeats the following operation using the Kalman filter. Specifically, in the estimation segment Li (i is a natural number equal to or greater than 2), the arithmetic system 47 applies the Kalman filter to estimated torques Dsim(i) calculated in the previous estimation segment Li−1 and measured values Dobs(i) of the torques acquired in the estimation segment Li to calculate post-estimated torques Dpos(i) in the estimation segment Li.

$$Dpos ( i ) = Dsim ( i ) + K ( Dobs ( i ) - Dsim ( i ) ) \qquad ( 28 )$$

K is a predetermined Kalman gain.

The arithmetic system 47 identifies a part of the model parameters of the polishing rate model and the polishing torque models using the measured polishing physical quantities including the post-estimated torques Dpos(i) as variables for identification to update the model parameters, updates the polishing rate model and the polishing torque models using the updated model parameters, and inputs the polishing conditions to the updated polishing rate model and polishing torque models to thereby calculate an estimated polishing rate MRRsim (i) of the workpiece W in the estimation segment Li and estimated torques Dsim(i+1) in the next estimation segment Li+1.

In the estimation segment Li+1, the arithmetic system 47 applies the Kalman filter to the estimated torques Dsim(i+1) calculated in the estimation segment Li and measured values Dobs(i+1) of the torques acquired in the estimation segment Li+1 to thereby calculate post-estimated torques Dpos(i+1) in the estimation segment Li+1. Furthermore, the arithmetic system 47 identifies a part of the model parameters of the polishing rate model and the polishing torque models using the measured polishing physical quantities including the post-estimated torques Dpos(i+1) as variables for identification to update the model parameters, updates the polishing rate model and the polishing torque models using the updated model parameters, and inputs the polishing conditions to the updated polishing rate model and polishing torque models to thereby calculate an estimated polishing rate MRRsim (i+1) of the workpiece W in the estimation segment Li+1 and estimated torques Dsim(i+2) in the next estimation segment Li+2. The same operation is repeated until the film thickness of the workpiece W reaches the target film thickness. As shown in FIG. 15, the estimated torques calculated in the previous estimation segment are used in the next estimation segment.

As in the embodiment described with reference to FIG. 12, after the estimated polishing rate is calculated in each estimation segment, the arithmetic system 47 determines the polishing time or polishing pressure for the next estimation segment.

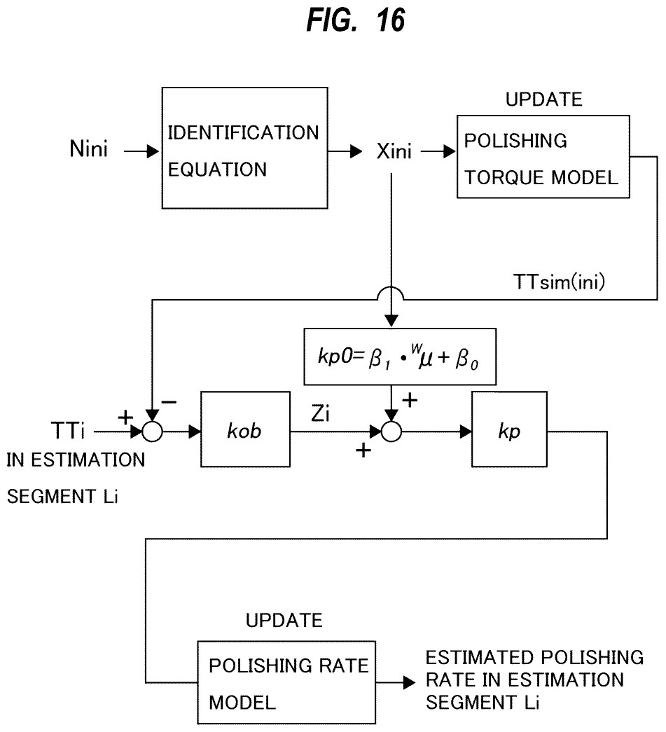

FIG. 16 is a block diagram illustrating yet another embodiment for polishing a workpiece using the chemical mechanical polishing system. In this embodiment, the arithmetic system 47 is configured to correct the Preston coefficient in the estimation segment and calculate an estimated polishing rate using the corrected Preston coefficient.

As shown in FIG. 16, first, a sample is polished by the polishing apparatus 1 using the polishing pad 2 in an initial state. The polishing pad 2 in the initial state is a polishing pad that has been subjected to a break-in process and has not yet been used to polish a workpiece. During or after polishing the sample using the polishing pad 2 in the initial state, the arithmetic system 47 acquires initial measured polishing physical quantities Nini. In one embodiment, the initial measured polishing physical quantities Nini includes a measured value of the polishing-pad rotation torque, a measured value of the polishing-head rotation torque, a measured value of the polishing-head oscillation torque, a measured value of the dresser oscillation torque, and an measured polishing rate of the sample during polishing of the sample.

The arithmetic system 47 executes the identification program using the initial measured polishing physical quantities Nini as variables for identification to identify (or determine) initial values Xini of the model parameters of the polishing rate model and the polishing torque models. Specifically, the arithmetic system 47 identifies the initial values Xini of the model parameters ^{R}μ, ^{D}μ, Wμ₁, ^{W}μ₀, β₁, β₀, α₁, α₂, and T by using the above identification equations (26) and (27).

The arithmetic system 47 updates the polishing torque models by substituting the initial values Xini of the model parameters into the polishing torque models expressed by the above equations (8), (13), (18), and (21). The arithmetic system 47 inputs the polishing conditions (e.g., the pressure of the polishing head 7 against the polishing pad 2, the rotation speed of the polishing head 7, the rotation speed of the polishing pad 2, the rotation speed of the dresser 50, the pressure of the dresser 50 against the polishing pad 2, etc.) into the polishing torque models to thereby calculate initial estimated torques TTsim(ini). In one embodiment, the polishing conditions input into the polishing torque models are the polishing conditions in the estimation segment Li. In one embodiment, the initial estimated torques TTsim(ini) comprises an initial estimated torque of the polishing pad 2.

The arithmetic system 47 acquires measured values TTi of the torques in the estimation segment Li during polishing of the workpiece W. In one embodiment, the measured values TTi of the torques comprises a measured value of the polishing-pad rotation torque during polishing of the workpiece W. The arithmetic system 47 calculates a difference (TTi−TTsim(ini)) between the measured value TTi of torque and the initial estimated torque TTsim(ini), and further multiplies the calculated difference by a correction coefficient kob to determine a correction amount Zi. The correction coefficient kob is a predetermined numerical value. The correction amount Zi is expressed by the following equation.

$$Zi = ( TTi - TTsim ( ini ) ) * kob \qquad ( 29 )$$

The arithmetic system 47 calculates an initial Preston coefficient kₚ0 from initial values Xini of the model parameters. More specifically, the arithmetic system 47 determines the initial Preston coefficient kₚ0 by using β₁, β₀, and ^{W}μ included in the initial values Xini of the model parameters (kₚ0=β₁^{W}μ+β₀). The arithmetic system 47 corrects the initial Preston coefficient kₚ0 by adding the correction amount Zi to the initial Preston coefficient kₚ0 to determine the corrected Preston coefficient kₚ. The corrected Preston coefficient kₚ is expressed by the following equation.

$$\begin{matrix}{k}_{p} = kp 0 + Zi \\ = {k}_{p} 0 + ( TTi - TTsim ( ini ) ) * kob\end{matrix} \qquad ( 30 )$$

The arithmetic system 47 updates the polishing rate models by substituting the corrected Preston coefficient kₚ into the polishing rate model expressed by the above equation (1). The polishing rate model expressed by the above equation (1) is stored in advance in the memory 47a of the arithmetic system 47.

The arithmetic system 47 inputs the polishing conditions in the next estimation segment Li+1 (e.g., the pressure of the polishing head 7 on the polishing pad 2, the rotational speed of the polishing head 7, the rotational speed of the polishing pad 2, the rotational speed of the dresser 50, the pressure of the dresser 50 on the polishing pad 2, etc.) into the updated polishing rate model to calculate the estimated polishing rate in the next estimation segment Li+1.

In one embodiment, the above-mentioned processes of obtaining the measured values TTi of the torques, calculating the correction amount Zi, calculating the corrected Preston coefficient kp, updating the polishing rate model, and calculating the estimated polishing rate in the next estimation segment may be performed for each estimation segment.

As in the embodiment described with reference to FIG. 12, after the estimated polishing rate is calculated in the estimation segment, the arithmetic system 47 determines the polishing time or polishing pressure for the next estimation segment.

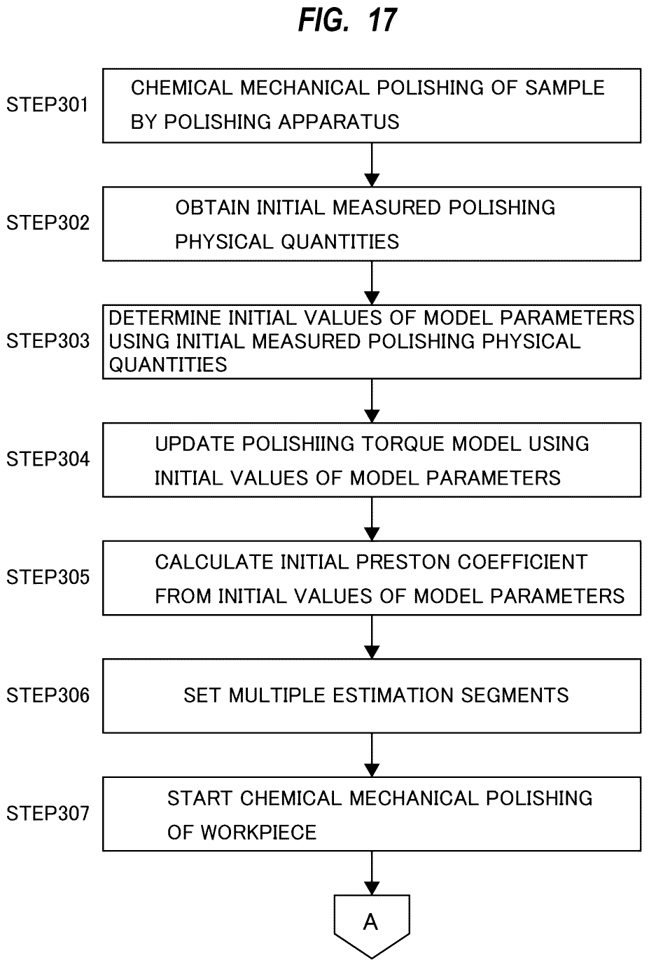

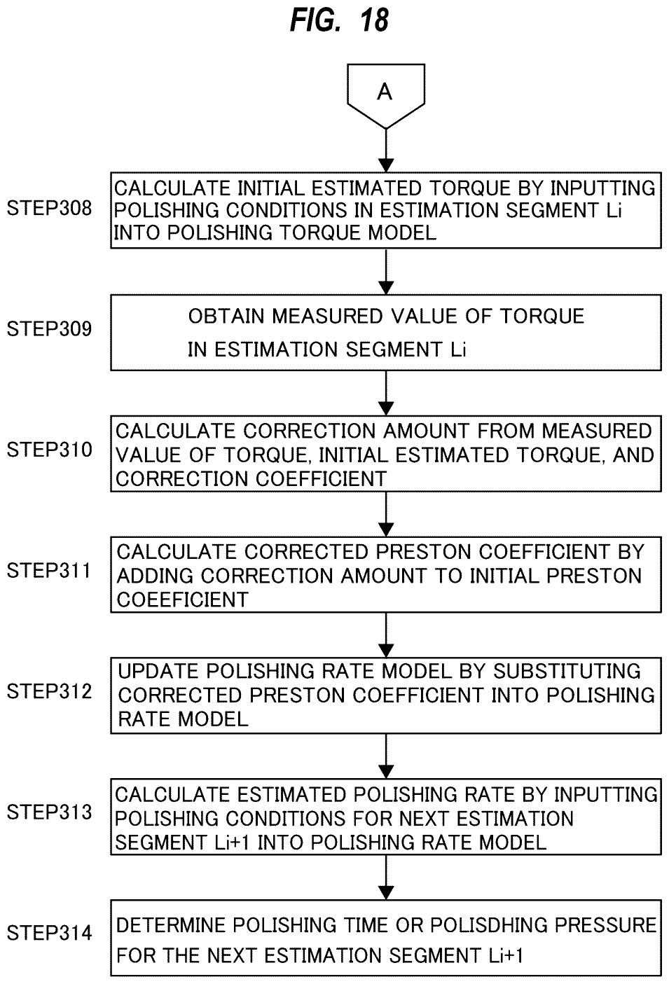

FIGS. 17 and 18 are flow charts of the embodiment described with reference to FIG. 16.

In step 301, the polishing apparatus 1 performs the chemical mechanical polishing of the sample using the polishing pad 2 in an initial state.

In step 302, the arithmetic system 47 acquires the initial measured polishing physical quantities N ini during or after polishing of the sample.

In step 303, the arithmetic system 47 operates according to the identification program using the initial measured polishing physical quantities Nini as variables for identification to determine the initial values Xini of the model parameters.

In step 304, the arithmetic system 47 updates the polishing torque models by substituting the initial values Xini of the model parameters into the polishing torque models.

In step 305, the arithmetic system 47 calculates the initial Preston coefficient kₚ0 from the initial values Xini of the model parameters (kₚ0=β₁ ^{W}μ+β₀).

In step 306, the arithmetic system 47 sets the multiple estimation segments in the polishing time of the workpiece W.

In step 307, the polishing apparatus 1 starts the chemical mechanical polishing of the workpiece W.

In step 308, the arithmetic system 47 calculates the initial estimated torques TTsim(ini) by inputting the polishing conditions in the estimation segment Li into the updated polishing torque models.

In step 309, the arithmetic system 47 obtains measured values TTi of the torques in the estimation segment Li during polishing of the workpiece W. In one embodiment, the measured values TTi of the torques comprise the measured value of the torque of the polishing pad 2 (i.e., the measured value of the torque of the polishing table 5).

In step 310, the arithmetic system 47 calculates the correction amount Zi by multiplying the predetermined correction coefficient kob by the difference between the measured value TTi of torque and the initial estimated torque TTsim(ini).

In step 311, the arithmetic system 47 determines the corrected Preston coefficient kₚ by adding the correction amount Zi to the initial Preston coefficient kₚ0.

In step 312, the arithmetic system 47 updates the polishing rate model by substituting the corrected Preston coefficient kₚ into the polishing rate model.

In step 313, the arithmetic system 47 calculates the estimated polishing rate of the workpiece W in the estimation segment Li+1 by inputting the polishing conditions for the next estimation segment Li+1 into the updated polishing rate model.

In step 314, the arithmetic system 47 determines the polishing time or polishing pressure for the workpiece W in the next estimation segment Li+1. In one embodiment, the polishing time of the workpiece W in the next estimation segment Li+1 is determined by the arithmetic system 47 as follows. Specifically, the arithmetic system 47 calculates the polishing amount of the workpiece W in the estimation segment Li from the estimated polishing rate and polishing time of the workpiece W in the estimation segment Li, calculates a difference between the target polishing amount of the workpiece W in the next estimation segment Li+1 and the polishing amount in the estimation segment Li, and calculates the polishing time in the next estimation segment Li+1 based on the calculated difference and the estimated polishing rate of the workpiece W in the estimation segment Li. In another embodiment, the arithmetic system 47 may calculate the polishing time in the next estimation segment Li+1 based on the estimated polishing rate of the workpiece W in the estimation segment Li and the target polishing amount of the workpiece W in the next estimation segment Li+1.

In one embodiment, the polishing pressure pi+1 for the workpiece W in the next estimation segment Li+1 is determined by the arithmetic system 47 as follows. Specifically, the arithmetic system 47 calculates a response rate of polishing rate per unit polishing pressure (polishing rate/polishing pressure) from polishing pressure data obtained in polishing of the workpiece W in the estimation segment Li and the estimated polishing rate of the workpiece W in the estimation segment Li, and calculates the polishing pressure pi+1 for the workpiece W in the next estimation segment Li+1 based on the calculated response rate, the target polishing amount of the workpiece W in the next estimation segment Li+1, and the polishing time in the estimation segment Li.

The polishing time or polishing pressure determined in the step 313 is applied to polishing of the workpiece W in the next estimation segment Li+1, and is used as the polishing conditions for polishing the workpiece W.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

What is claimed is:

1. A chemical-mechanical-polishing system comprising:
a polishing apparatus including a polishing table configured to support a polishing pad having a polishing surface, a polishing head configured to press a workpiece against the polishing surface, and a slurry supply nozzle configured to supply a slurry onto the polishing surface; and
an arithmetic system having a memory storing therein a simulation model configured to output estimated polishing physical quantities including an estimated polishing rate of the workpiece and an estimated torque which is an estimated value of a torque generated in the polishing apparatus due to a sliding resistance of the polishing pad,
wherein the simulation model includes a polishing rate model configured to calculate the estimated polishing rate and a polishing torque model configured to calculate the estimated torque,
the memory stores an identification program configured to determine model parameters of the simulation model,
the arithmetic system is configured to:
acquire measured polishing physical quantities including a measured polishing rate of a first workpiece and a measured value of the torque during or after polishing of the first workpiece;
identify the model parameters of the simulation model using the measured polishing physical quantities as variables for identification; and
input polishing conditions for a second workpiece into the simulation model to calculate an estimated polishing rate of the second workpiece.

2. The chemical-mechanical-polishing system according to claim 1, wherein the arithmetic system is configured to:
calculate differences between predetermined reference model parameters and the model parameters by subtracting the model parameters from the predetermined reference model parameters after the model parameters are identified; and
update the simulation model by substituting the differences as corrected model parameters into the simulation model.

3. The chemical-mechanical-polishing system according to claim 1, wherein the arithmetic system is configured to:
calculate a correction amount based on differences between estimated polishing physical quantities obtained from polishing of a previous workpiece performed before polishing of the first workpiece and measured polishing physical quantities obtained from polishing of the previous workpiece; and
determine the model parameters for the first workpiece by adding the correction amount to model parameters obtained from polishing of the previous workpiece.

4. A chemical-mechanical-polishing method of polishing a workpiece using a polishing apparatus including a polishing table supporting a polishing pad having a polishing surface, a polishing head configured to press the workpiece against the polishing surface, and a slurry supply nozzle configured to supply a slurry onto the polishing surface, said method comprising:
polishing a first workpiece with the polishing apparatus;
during or after polishing of the first workpiece, acquiring measured polishing physical quantities including a measured polishing rate of the first workpiece and a measured value of torque generated in the polishing apparatus due to a sliding resistance of the polishing pad;
identifying model parameters of a simulation model using the measured polishing physical quantities as variables for identification by an arithmetic system which includes an identification program configured to determine the model parameters of the simulation model, the simulation model including a polishing rate model configured to calculate an estimated polishing rate of a workpiece and a polishing torque model configured to calculate an estimated torque as an estimated value of the torque; and
inputting polishing conditions for a second workpiece into the simulation model to calculate an estimated polishing rate of the second workpiece.

5. The chemical-mechanical-polishing method according to claim 4, further comprising:
calculating differences between predetermined reference model parameters and the model parameters by subtracting the model parameters from the predetermined reference model parameters after the model parameters are identified; and
updating the simulation model by substituting the differences as corrected model parameters into the simulation model.

6. The chemical-mechanical-polishing method according to claim 4, wherein determining the model parameters of the simulation model comprises:
calculating a correction amount based on differences between estimated polishing physical quantities obtained from polishing of a previous workpiece performed before polishing of the first workpiece and measured polishing physical quantities obtained from polishing of the previous workpiece; and
determining the model parameters for the first workpiece by adding the correction amount to model parameters obtained from polishing of the previous workpiece.

7. A chemical-mechanical-polishing system comprising:
a polishing apparatus including a polishing table configured to support a polishing pad having a polishing surface, a polishing head configured to press a workpiece against the polishing surface, and a slurry supply nozzle configured to supply a slurry onto the polishing surface; and
an arithmetic system having a memory storing therein a simulation model configured to output estimated polishing physical quantities including an estimated polishing rate of the workpiece and an estimated torque which is an estimated value of a torque generated in the polishing apparatus due to a sliding resistance of the polishing pad,
wherein the simulation model includes a polishing rate model configured to calculate the estimated polishing rate and a polishing torque model configured to calculate the estimated torque,
the memory stores an identification program configured to determine model parameters of the simulation model,
the arithmetic system is configured to:
identify the model parameters of the simulation model using, as variables for identification, a measured polishing rate and a measured torque obtained in polishing of a previous workpiece performed before polishing of the workpiece;
set multiple estimation segments in a polishing time of the workpiece;
acquire measured polishing physical quantities including a measured value of the torque in one of the multiple estimation segments during polishing of the workpiece;
update the model parameters of the simulation model by identifying a part of the model parameters using the measured polishing physical quantities as variables for identification;
update the simulation model using the updated model parameters; and
input polishing conditions into the updated simulation model to calculate an estimated polishing rate of the workpiece in the one of the multiple estimation segments.

8. The chemical-mechanical-polishing system according to claim 7, wherein the arithmetic system is configured to:
calculate a post-estimated torque by applying a Kalman filter to an estimated torque calculated using the polishing torque model in an estimation segment prior to the one of the multiple estimation segments and the measured value of the torque obtained in the one of the multiple estimation segments; and
update the model parameters of the simulation model by identifying a part of the model parameters using the measured polishing physical quantities including the post-estimated torque as variables for identification.

9. A chemical-mechanical-polishing method of polishing a workpiece using a polishing apparatus including a polishing table supporting a polishing pad having a polishing surface, a polishing head configured to press the workpiece against the polishing surface, and a slurry supply nozzle configured to supply a slurry onto the polishing surface, said method comprising:
identifying model parameters of a simulation model using, as variables for identification, a measured polishing rate and a measured torque obtained in polishing of a previous workpiece performed before polishing of the workpiece, the simulation model including a polishing rate model configured to calculate an estimated polishing rate of the workpiece and a polishing torque model configured to calculate an estimated torque which is an estimated value of a torque generated in the polishing apparatus due to a sliding resistance of the polishing pad;
setting multiple estimation segments in a polishing time of the workpiece;
acquiring measured polishing physical quantities including a measured value of the torque in one of the multiple estimation segments during polishing of the workpiece;
updating the model parameters of the simulation model by identifying a part of the model parameters using the measured polishing physical quantities as variables for identification;
updating the simulation model using the updated model parameters; and
inputting polishing conditions into the updated simulation model to calculate an estimated polishing rate of the workpiece in the one of the multiple estimation segments.

10. The chemical-mechanical-polishing method according to claim 9, further comprising:
calculating a post-estimated torque by applying a Kalman filter to an estimated torque calculated using the polishing torque model in an estimation segment prior to the one of the multiple estimation segments and the measured value of the torque obtained in the one of the multiple estimation segments,
wherein updating the simulation model comprises updating the model parameters of the simulation model by identifying a part of the model parameters using the measured polishing physical quantities including the post-estimated torque as variables for identification.

11. A chemical-mechanical-polishing system comprising:
a polishing apparatus including a polishing table configured to support a polishing pad having a polishing surface, a polishing head configured to press a workpiece against the polishing surface, and a slurry supply nozzle configured to supply a slurry onto the polishing surface; and
an arithmetic system having a memory storing therein a simulation model configured to output estimated polishing physical quantities including an estimated polishing rate of the workpiece and an estimated torque which is an estimated value of a torque generated in the polishing apparatus due to a sliding resistance of the polishing pad,
wherein the simulation model includes a polishing rate model configured to calculate the estimated polishing rate and a polishing torque model configured to calculate the estimated torque,
the memory stores an identification program configured to determine model parameters of the simulation model,
the arithmetic system is configured to:
obtain initial measured polishing physical quantities from polishing of a sample using the polishing pad in an initial state;
determine initial values of the model parameters using the initial measured polishing physical quantities as variables for identification;
calculate an initial Preston coefficient from the initial values of the model parameters;
set multiple estimation segments in a polishing time of the workpiece;
input polishing conditions into the simulation model to calculate an initial estimated torque;
obtain a measured value of the torque in a first estimation segment of the multiple estimation segments during polishing of the workpiece;
calculate a correction amount by multiplying a difference between the measured value of the torque and the initial estimated torque by a predetermined correction coefficient;
determine a corrected Preston coefficient by adding the correction amount to the initial Preston coefficient;
update the polishing rate model by substituting the corrected Preston coefficient into the polishing rate model; and
calculate an estimated polishing rate of the workpiece in a second estimation segment of the multiple estimation segments by inputting polishing conditions for the second estimation segment into the polishing rate model.

12. A chemical-mechanical-polishing method of polishing a workpiece using a polishing apparatus including a polishing table supporting a polishing pad having a polishing surface, a polishing head configured to press the workpiece against the polishing surface, and a slurry supply nozzle configured to supply a slurry onto the polishing surface, said method comprising:
obtaining initial measured polishing physical quantities from polishing of a sample using the polishing pad in an initial state;
identifying initial values of model parameters of a simulation model using the initial measured polishing physical quantities as variables for identification by an arithmetic system which includes an identification program configured to determine the model parameters of the simulation model, the simulation model including a polishing rate model configured to calculate an estimated polishing rate of the workpiece and a polishing torque model configured to calculate an estimated torque as an estimated value of a torque generated in the polishing apparatus due to a sliding resistance of the polishing pad;
calculating an initial Preston coefficient from the initial values of the model parameters;
setting multiple estimation segments in a polishing time of the workpiece;
inputting polishing conditions into the simulation model to calculate an initial estimated torque;
obtaining a measured value of the torque in a first estimation segment of the multiple estimation segments during polishing of the workpiece;
calculating a correction amount by multiplying a difference between the measured value of the torque and the initial estimated torque by a predetermined correction coefficient;
determining a corrected Preston coefficient by adding the correction amount to the initial Preston coefficient;
updating the polishing rate model by substituting the corrected Preston coefficient into the polishing rate model; and
calculating an estimated polishing rate of the workpiece in a second estimation segment of the multiple estimation segments by inputting polishing conditions for the second estimation segment into the polishing rate model.
